(19) United States
(12) Patent Application Publication
(10) Pub. No.: US 2007/0201934 A1
(43) Pub. Date: Aug. 30, 2007

(54) Print medium and tape producing apparatus

(75) Inventor: Akira Ito, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 11/702,287

(22) Filed: Feb. 5, 2007

(30) Foreign Application Priority Data
Feb. 27, 2006 (JP) 2006-049617

(51) Int. Cl. B41J 11/00

(52) U.S. Cl. 400/615.2

(57) ABSTRACT

An object of the disclosure is to provide a print medium including an upper and lower parts on which characters are printable and dividing the printed upper and lower parts well without using scissors or the like, while allowing adhering to anything without dividing the upper and lower parts when characters are printed transversely across the width, and to provide a tape producing apparatus capable of printing on the upper and lower parts of the print medium separately or on those parts transversely across the width. A print medium is therefore formed of a divisible print tape assembly including a divisible print tape and a divisible double-sided adhesive tape previously adhered to the tape and is arranged to print characters and symbols on a surface of the divisible print tape with ink. An adhesive material of the double-sided adhesive tape is formed with a slit extending perpendicular to a width direction of the double-sided adhesive tape. The divisible print tape has an easy splitting property in the same direction as the slit of the adhesive material.

### CROSS-REFERENCE TO RELATED APPLICATIONS

This application claims priority from JP 2006-049617 filed Feb. 27, 2006, the contents of which are hereby incorporated by reference.

### TECHNICAL FIELD

The disclosure relates to a print medium and tape producing apparatus and more particularly to a print medium having an easy splitting property and a tape producing apparatus using the print medium having the easy splitting property.

### BACKGROUND

Conventionally, this applicant has proposed a document processing apparatus comprising a keyboard, representing display and print mechanism and capable of printing characters, symbols and others on a tape, for example, 6, 9, 12, 18, 24, 36 mm in width as a print medium, this document processing apparatus being preferable for producing a tape-like label suitable for being affixed to the rear cover of a file, and having a variety of editing functions, through Japanese Utility Model Application Laid-Open No. 1(1989)-85050.

In the document processing apparatus, the tape width can be changed by replacing a tape cassette and characters are printed in a character size set corresponding to the tape width.

In case where tapes of the same shape are produced in a large quantity, there is an inconvenience that the cassette tape has to be replaced frequently. In this case, although a method of printing the same content on upper and lower two rows (parts) and then cutting them out by means of scissors is available, it is difficult to cut well despite that it takes labor and time, so that the appearance of an object may be damaged when the cut tape is bonded thereto. Further, there is another problem that the quantity of the tape cannot be increased further because the volume of the tape cassette is determined.

As a method for solving the above-mentioned problem, Japanese Patent Application Laid-Open No. 2002-240356 discloses a print medium to be contained in a tape cassette, comprising a print tape main body in which adhesive base layer is formed on the rear face of a printing surface thereof and a release paper integrated with the print tape main body via the adhesive base layer while the print tape main body contains incisions formed in the length direction so as to be separable to plural tapes when it is peeled from the release paper.

Although the print medium contained in the above-mentioned disclosed tape cassette has eliminated the inconvenience of replacing the tape cassette frequently when producing the same type tape in a large quantity, there still exists such a problem that when characters are printed across a total tape width, the printed characters may be deflected from each other thereby damaging the appearance to see if divided tapes are affixed in line. Further, since the characters and others are printed such that a printed surface comes to the front when the tape is affixed to an object, another problem would occur that the characters may become illegible because ink is peeled out due to rubbing during use.

### SUMMARY

The disclosure has been made in view of the above circumstance and has an object to provide a print medium comprising a print tape having an easy splitting property so that characters if printed on upper and lower parts arranged in a direction of a tape width may be divided well without use of scissors or the like owing to the easy splitting property, thereby producing a number of tapes equal in shape, while the print medium has so rubbing resistance as to be affixed as it is without being divided when characters are printed on the print medium across its total width, and also to provide a tape producing apparatus having a print control function which allows both the print on the print medium to be divided and the print on the identical print medium across its total width.

To achieve the above object of the disclosure, there is provided a print medium comprising a print tape and a double-sided adhesive tape, the print tape having a surface on which characters and symbols are to be printed with ink adhered thereto, wherein the double-sided adhesive tape includes an adhesive base material formed with a slit extending in a direction perpendicular to a width of the double-sided adhesive tape, and the print tape has an easy splitting property of being split in the same direction as the extending direction of the slit of the double-sided adhesive tape.

The above print medium comprises the print tape and double-sided adhesive tape, in which characters or symbols are to be printed by applying ink to the surface of the print tape. The adhesive base material constituting the double-sided adhesive tape has the slit extending perpendicular to the width direction of the double-sided adhesive tape and the print tape is imparted with the easy splitting property of being able to be split in the same direction as the slit in the adhesive base material constituting the double-sided adhesive tape. Consequently, after characters and others are printed on the print medium on both sides of the slit in the adhesive base material constituting the double sided adhesive tape, the printed tape can be split at the slit portion in the adhesive base material using the easy splitting property in the same direction as the adhesive base material so as to divide the printed tape to smaller parts. As a result, at least double printed tapes can be produced from a single print tape. Further, the print tape can be split easily with hands without use of scissors or the like because it has the easy splitting property. Still further, the adhesive base material constituting the double sided adhesive tape serves as a reinforcing member in splitting the print tape at the slit portion provided in the adhesive base material of the double-sided adhesive tape so as to prevent the print tape from being split at portions other than the slit portion provided in the adhesive base material.

On the other hand, if characters and others are printed across the tape width, the print tape can be affixed as a single print tape without being divided. For the reason, the problem that after characters and others are printed on a print tape having the slit, the printed characters may be deflected from each other when the tapes divided at the slit are affixed together can be solved.

This print tape allows plural printed tapes having different widths to be produced from a single print tape. Thus, inconvenience of replacing the tape corresponding to the width of a tape to be produced each time can be eliminated.

According to another aspect of the disclosure, there is provided A print medium comprising a print tape and a double-sided adhesive tape, the print tape having a surface on which letters and symbols are to be printed with ink adhered thereto and the surface being bonded to the double-sided adhesive tape, wherein the double-sided adhesive tape includes an adhesive base material formed with a slit extending in a direction perpendicular to a width of the double-sided adhesive tape, and the print tape has an easy splitting property of being split in the same direction as the extending direction of the slit of the double-sided adhesive tape after the print tape is bonded to the double-sided adhesive tape.

The above print medium comprises the print tape and double-sided adhesive tape in which after ink is applied to the surface of the print tape so as to print characters or symbols, its printed face and the double-sided adhesive tape are bonded to each other. The adhesive base material constituting the double-sided adhesive tape has the slit extending perpendicular to the width direction of the double-sided adhesive tape and the print tape has the easy splitting property of being able to be split in the same direction as the slit in the adhesive base material constituting the double-sided adhesive tape. Consequently, in addition to the above-described advantage, printed characters or symbols on the printed face are protected with the print tape by bonding the printed face and the double-sided adhesive tape together after the characters or symbols are printed on the surface of the print tape by applying ink thereto. This makes it possible to prevent the problem that the printed characters or symbols are likely to become illegible because the ink is peeled out due to rubbing during use.

### BRIEF DESCRIPTION OF THE DRAWINGS

FIG. 1 is a perspective view of a tape producing apparatus of a first embodiment;

FIG. 2 is a perspective view of a state in which a housing cover of a tape cassette holding portion of the tape producing apparatus is opened;

FIG. 3 is a plan view showing major portions of a laminate type divisible tape cassette when loaded in the tape producing apparatus, excluding an upper case of the tape cassette;

FIG. 4 is an explanatory diagram for explaining steps of printing characters and the like on the divisible print tape and bonding a divisible double-sided adhesive tape so as to produce a laminate type label tape;

FIG. 5 is a plan view showing major portions of a receptor type divisible tape cassette when loaded in the tape producing apparatus, excluding an upper case of the tape cassette;

FIG. 6 is an explanatory diagram for explaining steps of printing characters and the like on a divisible print tape assembly and passing this divisible print tape assembly between a tape drive roller and a feed roller so as to produce a receptor type label tape;

FIG. 7 is a block diagram showing a control configuration of the tape producing apparatus;

FIG. 8 is a flow chart for producing a label tape by printing the divisible print tape;

FIG. 9 is a flow chart for producing a label tape by printing the divisible print tape;

FIG. 10 is a flow chart for producing a label tape by printing the divisible print tape;

FIG. 11 is a flow chart for producing a label tape by printing the divisible print tape;

FIG. 12 is an explanatory diagram for explaining a state in which the content of a tape cassette set in the tape cassette holding portion and a selected character size are displayed on the LCD;

FIG. 13 is an explanatory diagram for explaining an example of a label tape 24 mm in width in which characters are printed straddling a slit;

FIG. 14 is an explanatory diagram for explaining a state in which the content of a tape cassette set in the tape cassette holding portion and a selected character size are displayed on the LCD;

FIG. 15 is an explanatory diagram for explaining an example of a label tape 24 mm in width in which the same characters are printed on print tapes arranged in parallel;

FIG. 16 is an explanatory diagram for explaining an example of a label tape 24 mm in width in which different characters are printed on print tapes arranged in parallel;

FIG. 17 is an explanatory diagram for explaining a state in which the content of a tape cassette set in the tape cassette holding portion and a selected character size are displayed on the LCD;

FIG. 18 is an explanatory diagram for explaining an example of a label tape 36 mm in width in which characters are printed straddling a slit;

FIG. 19 is an explanatory diagram for explaining a state in which the content of a tape cassette set in the tape cassette holding portion and a selected character size are displayed on the LCD;

FIG. 20 is an explanatory diagram for explaining an example of a label tape 36 mm in width in which the same characters are printed on print tapes arranged in parallel;

FIG. 21 is an explanatory diagram for explaining an example of a label tape 36 mm in width in which different characters are printed on print tapes arranged in parallel;

FIG. 22 is an explanatory diagram for explaining a state in which the content of a tape cassette set in the tape cassette holding portion and a selected character size are displayed on the LCD;

FIG. 23 is an explanatory diagram for explaining an example of a label tape 36 mm in width in which the same characters are printed on upper, middle and lower print tapes arranged in parallel;

FIG. 24 is an explanatory diagram for explaining an example of a label tape 36 mm in width in which different characters are printed on upper, middle and lower print tapes arranged in parallel;

FIG. 25 is an explanatory diagram for explaining an example of a label tape 36 mm in width in which characters are printed straddling two slits;

FIG. 26 is an explanatory diagram for explaining a state in which the content of a tape cassette set in the tape cassette holding portion and a selected character size are displayed on the LCD;

FIG. 27 is an explanatory diagram for explaining a state in which the content of a tape cassette set in the tape cassette holding portion and a selected character size are displayed on the LCD;

FIG. 28 is an explanatory diagram for explaining an example of a label tape 36 mm in width in which characters are printed on upper two rows of a divisible print tape straddling a slit while other characters are printed on a lower row;

FIG. 29 is an explanatory diagram for explaining a state in which the content of a tape cassette set in the tape cassette holding portion and a selected character size are displayed on the LCD;

FIG. 30 is an explanatory diagram for explaining a state in which the content of a tape cassette set in the tape cassette holding portion and a selected character size are displayed on the LCD;

FIG. 31 is an explanatory diagram for explaining an example of a label tape 36 mm in width in which characters are printed on an upper row of the divisible print tape while other characters are printed on lower two rows straddling a single adhesive base material slit;

FIG. 32 is an explanatory diagram for explaining the process of printing characters and others on the divisible print tape and bonding the divisible double-sided adhesive tape so as to produce a laminate type label tape;

FIG. 33 is an explanatory diagram for explaining the process of printing characters and others on the divisible print tape assembly and passing between a tape drive roller and a feed roller so as to produce a receptor type label tape;

FIG. 34 is an explanatory diagram for explaining the process of printing characters and others on the divisible print tape and bonding the divisible double-sided adhesive tape so as to produce a laminate type label tape;

FIG. 35 is an explanatory diagram for explaining the process of printing characters and others on the divisible print tape assembly and passing between the tape drive roller and the feed roller so as to produce a receptor type label tape;

FIG. 36 is an explanatory diagram for explaining the process of printing characters and others on the divisible print tape and bonding the divisible double-sided adhesive tape so as to produce a laminate type label tape;

FIG. 36 is an explanatory diagram for explaining the process of printing characters and others on the divisible print tape and bonding the divisible double-sided adhesive tape so as to produce a laminate type label tape; and

FIG. 37 is an explanatory diagram for explaining the process of printing characters and others on the divisible print tape assembly and passing between the tape drive roller and the feed roller so as to produce a receptor type label tape.

### DETAILED DESCRIPTION

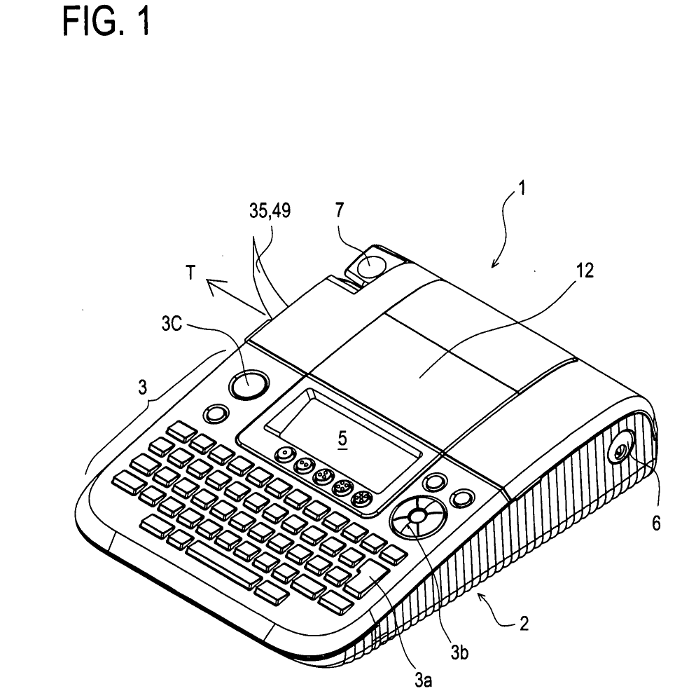

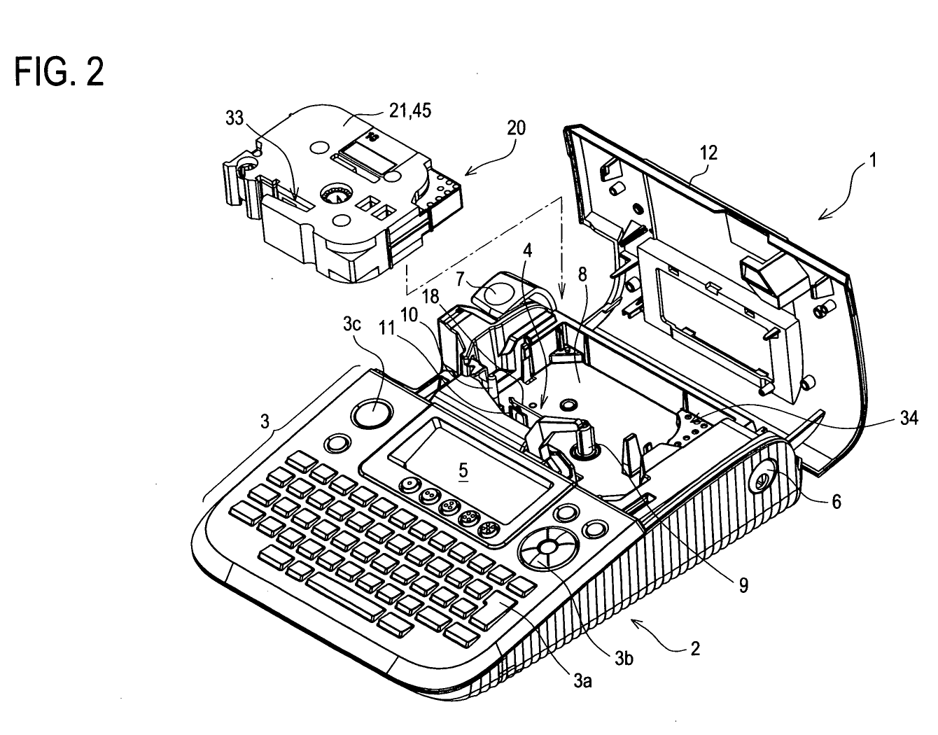

A detailed description of an exemplary embodiment of the disclosure will now be given referring to the accompanying drawings. First, a schematic structure of a tape producing apparatus 1 of the first embodiment will be described with reference to FIGS. 1 and 2. FIG. 1 is a perspective view of the tape producing apparatus of the first embodiment and FIG. 2 is a perspective view of a state in which a housing cover 12 of a tape cassette holding portion 8 of the tape producing apparatus 1 is opened.

Referring to FIGS. 1 and 2, a keyboard 3 is provided in a front part of a main body frame 2 of the tape producing apparatus 1 and a liquid crystal display (hereinafter referred to as “LCD”) 5 capable of displaying inputted characters and symbols is provided on an upper side of the keyboard 3. Further, a power switch 6 for turning on/off the power is provided on a rear side face on the right of the main body frame 2. Then, a cutter button 7 for cutting a label tape 35 or 49 is provided at a rear corner on the left of the main body frame 2.

The keyboard 3 includes character keys for inputting alphabetic letters, numerical letters and symbols, a space key, an ENTER key 3a, cursor move keys 3b, edition keys such as a back space key and a delete key and a print key 3c for instructing print. These keys are used for inputting alphabetic letters, numerical letters or symbols as required when producing a name tape, file rear cover tape, divisible tape in which plural tapes are arranged in parallel or the like by means of a tape producing apparatus 1.

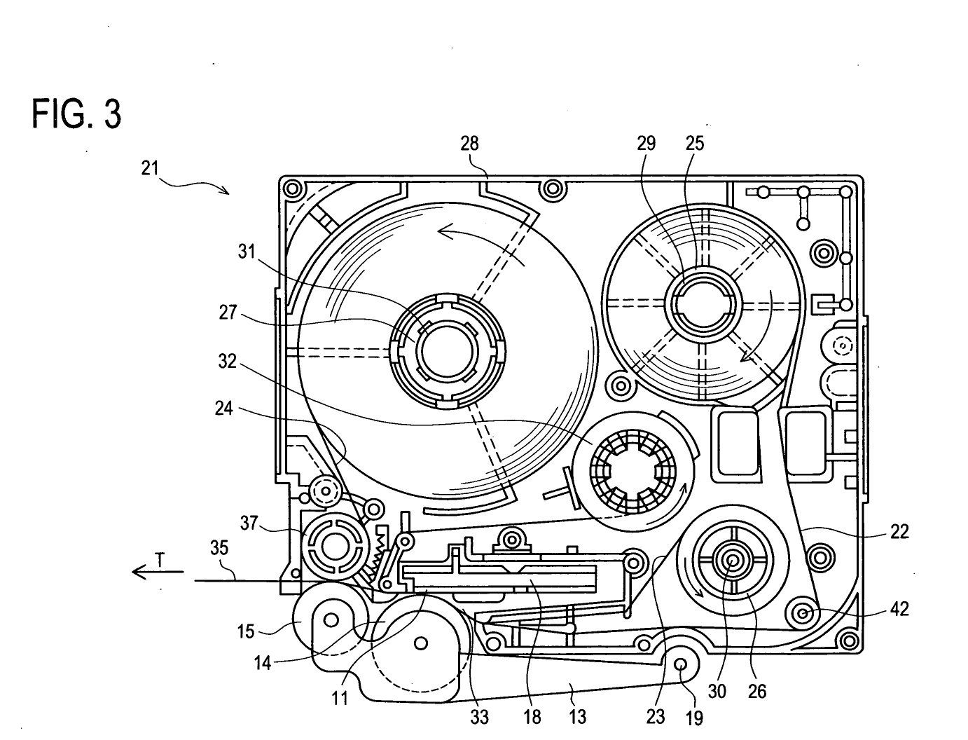

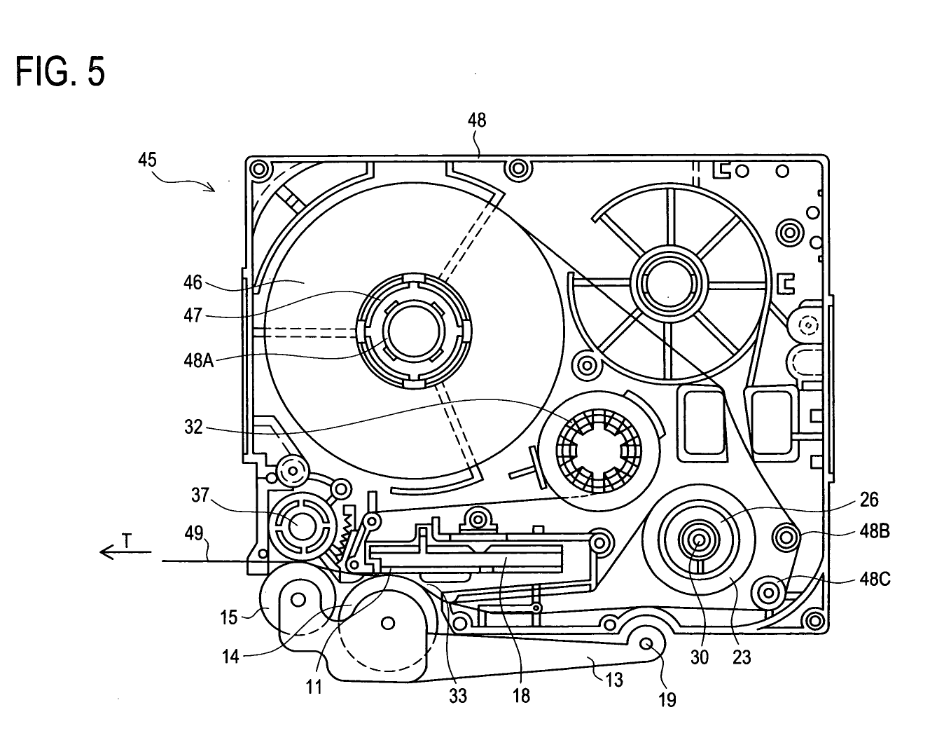

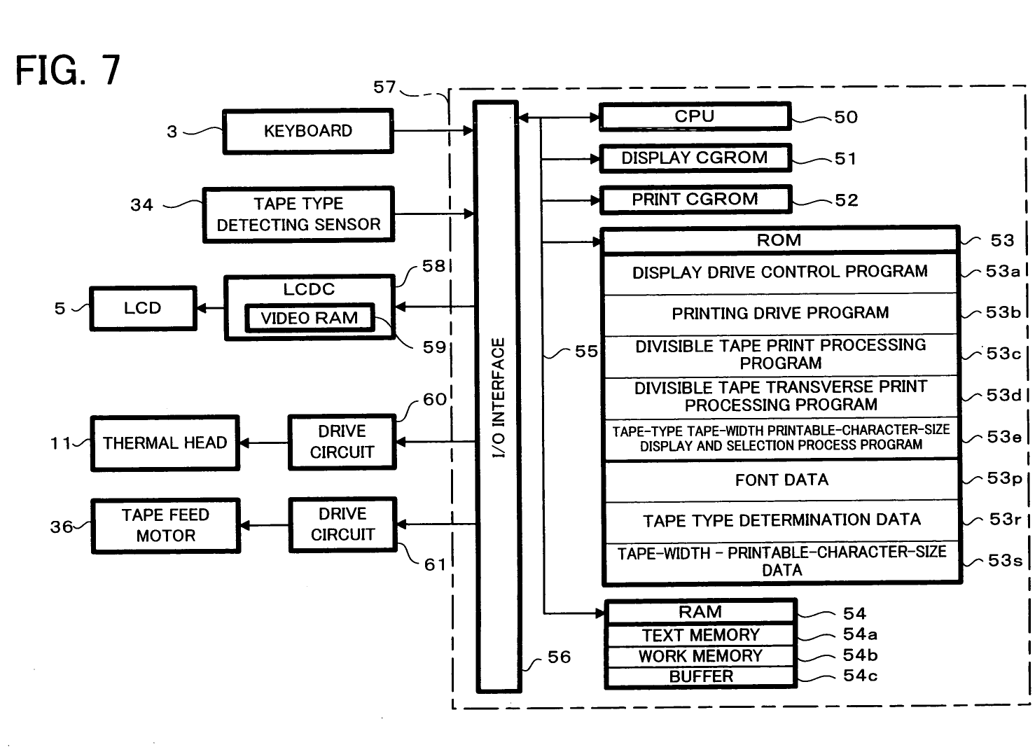

As shown in a state in which the housing cover 12 of FIG. 2 is opened, the tape cassette holding portion 8 which holds therein a divisible tape cassette 21 or 45 (see FIGS. 3 and 5) is provided in the back of the LCD 5 on the rear side of the main body frame 2. A ribbon winding shaft 9 which is driven by a tape feed motor 36 (see FIG. 7) via an appropriate drive mechanism is provided in an upright position in the tape cassette holding portion 8. The ribbon winding shaft 9 is inserted into an ink ribbon winding reel 32 (see FIGS. 3 and 5) which winds up an ink ribbon 23 after print and drives the ink ribbon winding reel 32 synchronously with a print speed.

A tape drive roller shaft 10 which is driven by the tape feed motor 36 constituted of a stepping motor or the like via an appropriate transmission mechanism so as to drive the tape drive roller 37 (see FIGS. 3 and 5) is provided in an upright position in oblique front of the ribbon winding shaft 9 (left bottom corner of the tape cassette holding portion 8 in FIG. 2). In front (on the side of the LCD 5 in FIG. 2) of the tape cassette holding portion 8, a thermal head 11 which prints characters and others on a divisible print tape 22 or a divisible print tape assembly 46 (see FIGS. 3 and 5) is mounted on a sub-frame 18 which serves to radiate heat at the same time such that it is located in an opening portion 33 when the divisible tape cassette 21 or 45 (see FIGS. 3 and 5) is loaded. A platen roller 14 and a feed roller 15 (see FIGS. 3 and 5) are supported rotatably by a roller support member 13 (see FIGS. 3 and 5) to face the thermal head 11, the roller support member 13 being arranged to be rotatable around a roller support member rotating shaft 19. The platen roller 14 and the feed roller 15 are designed to have a width corresponding to a tape width of 36 mm which is a maximum width of the divisible print tape 22 or a larger width than that. As the divisible tape cassette 21 or 45 (see FIGS. 3 and 5) described later, a plurality of the divisible tape cassettes 21 or 45 are available depending on a tape width or tape type. A plurality of tape type detecting holes 20 are formed in the bottom wall portion of the divisible tape cassette 21 or 45, so that a tape width or a tape type is determined depending on a combination of the tape type detecting holes 20 and this information is read by a tape type detecting sensor 34 (see FIGS. 2 and 7) placed on the right corner of the tape cassette holding portion 8. The tape cassette holding portion 8 is opened/closed by the housing cover 12 which is pivoted to be rotatable backward of the tape producing apparatus 1. The divisible tape cassette 21 or 45 may be replaced when the housing cover 12 is opened.

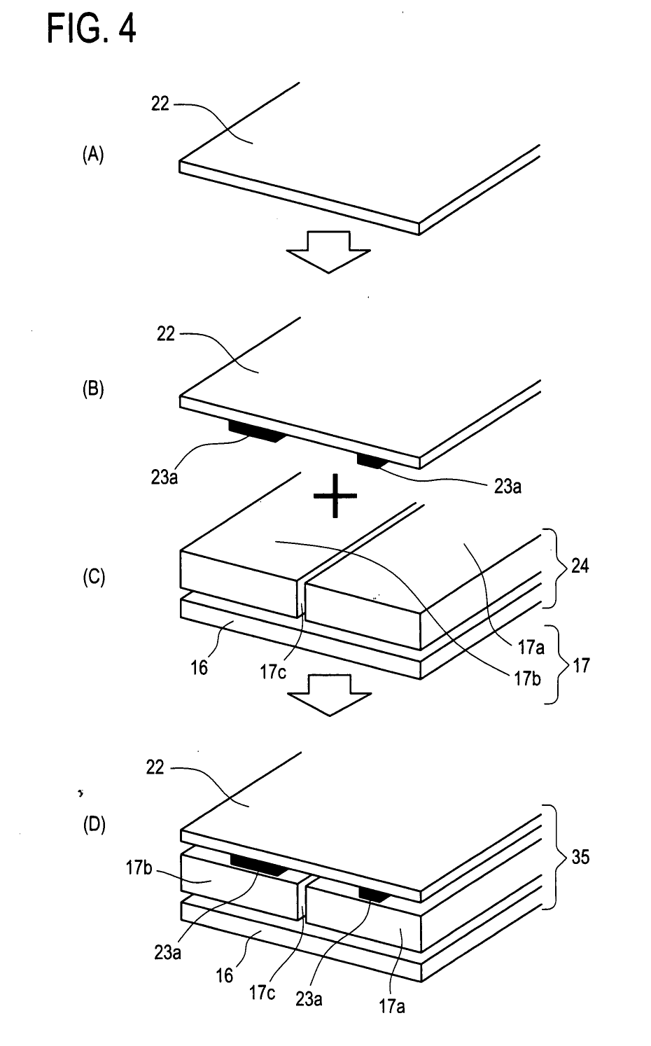

Next, the configuration of the laminate type divisible tape cassette 21 of the first embodiment will be described with reference to FIG. 3. FIG. 3 is a plan view showing major portions of the laminate type divisible tape cassette 21 when loaded in the tape producing apparatus 1, excluding an upper case of the divisible tape cassette 21. The divisible tape cassette 21 contains, as shown in FIG. 3, the divisible print tape 22 formed of transparent tape or the like having an easy splitting property in the length direction of the tape, the ink ribbon 23 for use in printing the divisible print tape 22, and a divisible double sided adhesive tape 24 (see FIG. 4(C)) comprising a right divisible adhesive base material 17a and a left divisible adhesive base material 17b, which are divided at an adhesive base material slit (hereinafter, simply “slit”) 17c and a release paper 16, this divisible double sided adhesive tape 24 being to be bonded to the rear side of a printed divisible print tape 22, which are wound around a tape spool 25, a reel 26, and a tape spool 27 respectively. This divisible tape cassette 21 is loaded in the tape producing apparatus 1 in such a manner that the tape spool 25, reel 26, and tape spool 27 are rotatably fitted on a cassette boss 29, a reel boss 30, and a cassette boss 31 respectively provided vertically extending from the bottom face of the cassette case main body 28. Further, an ink ribbon winding reel 32 for winding up used ink ribbon 23 is provided. As such divisible tape cassette 21, cassettes different in width of the divisible print tape 22, that is, 24 mm and 36 mm, are available although the tape width of an ordinary tape cassette is 6 mm, 9 mm, 12 mm, 18 mm, 24 mm and 36 mm. Depending on the tape widths, accordingly, the widths of the ink ribbon 23 and the divisible double-sided adhesive tape 24 differ among cassettes, the tape spools 25 and 27 and the reel 26 are also different in height among cassettes, and those cassettes are therefore different in thickness. A tape drive roller 37 which is rotated by a drive of the tape feed motor 36 is provided rotatably in a lower portion on one side of the divisible tape cassette 21. This tape drive roller 37 is designed to have an equal width to or slightly larger width than the divisible print tape 22 contained in the divisible tape cassette 21.

To produce an easy splitting property in the divisible print tape 22, a tape for use needs to be subjected to uniaxial drawing processing or biaxial drawing processing. Polymer film which has an easy splitting property when it is subjected to such processing and which can be used as the divisible print tape 22 may include “TOREFAN YT12, 22, TOREFAN YT42” produced by Toray Industries, Inc., “MITSUI HIBURON FILM, MITSUI NOBUREN FILM” produced by Mitsui Chemicals, Inc., “SUN TOX-MP TC02, SUN-TOX-OP DP30” produced by Sun Tox Co., Ltd., “EMBLEM NC, EMBLET PC” produced by Unitika Ltd., and “KARARIAN Y” produced by Denki Kagaku Kogyo Kabushiki Kaisha, etc.

An operator can select a desired color variation because the divisible double-sided adhesive tape 24 includes color variations other than white and the ink 23a to be printed on the divisible print tape 22 or the divisible print tape assembly 46 has color variations other than black.

Next, the process of producing the laminate type label tape 35 will be described with reference to FIGS. 3 and 4. FIG. 4 is an explanatory diagram for explaining the process of printing characters and others on the divisible print tape 22 and bonding the divisible double-sided adhesive tape 24 so as to produce the laminate type label tape 35. The divisible print tape 22 (FIG. 4(A)) unreeled from the tape spool 25 is overlapped with the unused ink ribbon 23 unreeled from the reel 26 through a guide pin 42 and the like and enters the opening portion 33 together with the ink ribbon 23 and when they pass between the thermal head 11 and the platen roller 14, characters and the like are printed (FIG. 4(B)). In this context, the platen roller 14 is arranged to press the thermal head 11 in a condition in which the divisible print tape 22 and the ink ribbon 23 are overlapped. After separated from the divisible print tape 22, the ink ribbon 23 comes to be wound up by the ink ribbon winding reel 32 driven by the ribbon winding shaft 9.

The divisible double-sided adhesive tape 24 with one side face overlapped with the release paper is wound around the tape spool 27 with the release paper facing outside and contained in the divisible tape cassettes 21. Then, after unreeled from this tape spool 27, the divisible double-sided adhesive tape 24 (FIG. 4(C)) passes between the tape drive roller 37 and the feed roller 15. The feed roller 15 presses the divisible print tape 22 after printed and an adhesive face on a side not overlapped with the release paper of the divisible double-sided adhesive tape 24 against the tape drive roller 37 so as to bond the divisible double-sided adhesive tape 24 to the divisible print tape 22 to produce the label tape 35 (FIG. 4(D)) and feed the tape in the direction of an arrow T. A spacer formed of a resin film (not shown) is placed at both upper and lower end portions of the divisible double-sided adhesive tape 24. In this way, the label tape 35 is produced.

Next, the structure of the receptor type divisible tape cassette 45 of the first embodiment will be described with reference to FIG. 5. FIG. 5 is a plan view showing major portions of the divisible tape cassette 45 when loaded in the tape producing apparatus 1, excluding an upper case of the divisible tape cassette 45. The structure of the divisible tape cassette 45 is substantially equal to that of the laminate type divisible tape cassette 21. The divisible print tape assembly 46, in which the divisible print tape 22 and the divisible double-sided adhesive tape 24 having the adhesive base material 17 divided at the slit 17c into the right divisible adhesive base material 17a and the left divisible adhesive base material 17b and the release paper 16 are bonded to each other preliminarily, are wound around the tape spool 47 with the release paper 16 facing outside. The tape spool 47 is rotatably fitted on a cassette boss 48A provided vertically extending from the bottom face of a cassette case main body 48. The ink ribbon 23 for use in printing this divisible print tape assembly 46 is rotatably fitted on the reel boss 30 provided vertically extending from the bottom face of the cassette case main body 48. A spacer made of resin film (not shown) is placed at upper and lower end portions of the divisible print tape assembly 46.

Further, an ink ribbon winding reel 32 for winding up used ink ribbon 23 is provided. As the divisible tape cassette 45, cassettes different in width of the divisible print tape assembly 46, that is, 24 mm and 36 mm, are available although the tape width of an ordinary tape cassette is 6 mm, 9 mm, 12 mm, 18 mm, 24 mm and 36 mm. Depending on the tape width, accordingly, the width of the ink ribbon 23 differs among cassettes, the tape spool 47 and reel 26 are also different in height among cassettes, and those cassettes are therefore different in thickness. The tape drive roller 37 which is rotated by a drive of the tape feed motor 36 is provided rotatably in a lower portion on one side (left side bottom in FIG. 3) of the divisible tape cassette 45. This tape drive roller 37 is designed to have an equal width to or a slightly larger width than the contained divisible print tape assembly 46.

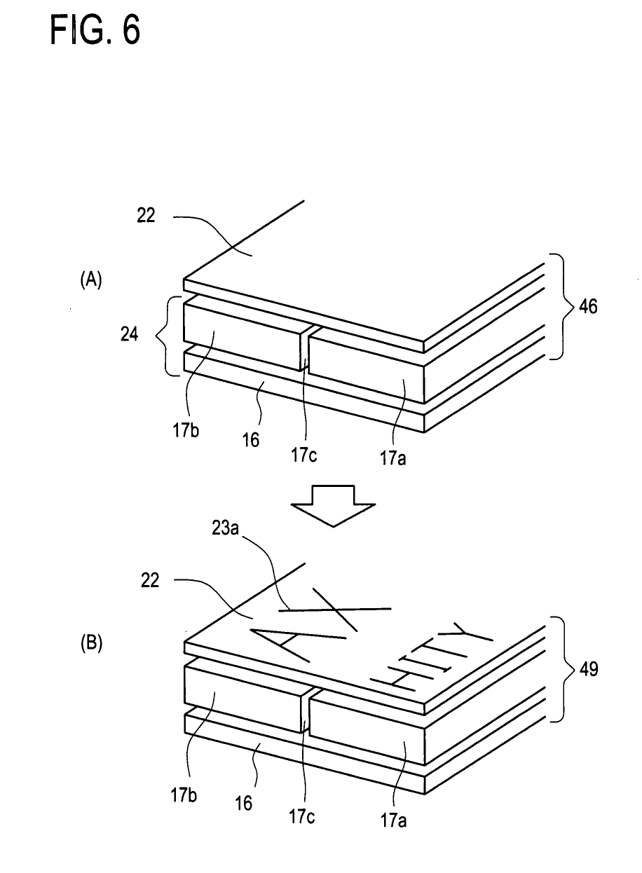

Next, the process of producing the receptor type label tape 49 will be described with reference to FIGS. 5 and 6. FIG. 6 is an explanatory diagram for explaining the process of printing characters and others on the divisible print tape assembly 46 and passing it between the tape drive roller 37 and the feed roller 15 so as to produce the receptor type label tape 49. The divisible print tape assembly 46 (FIG. 6(A)) unreeled from the tape spool 47 is overlapped with the unused ink ribbon 23 unreeled from the reel 26 through respective guide pins 48B and 48C and the like and enters the opening portion 33 together with the ink ribbon 23. When the divisible print tape assembly 46 and the ink ribbon 23 pass between the thermal head 11 and the platen roller 14, characters and others are printed. In this context, the platen roller 14 is arranged to press the divisible print tape assembly 46 and the ink ribbon 23 in an overlapping state against the thermal head 11 in printing. After that, the ink ribbon 23 is separated from the divisible print tape assembly 46 and then comes to be wound up by the ink ribbon winding reel 32 driven by the ribbon winding shaft 9.

Then, the divisible print tape assembly 46 printed by the thermal head 11 passes between the tape drive roller 37 and the feed roller 15. Here, the feed roller 15 is arranged to press a printed face of the divisible print tape assembly 46 against the tape drive roller 37 and feed the tape as the label tape 49 (FIG. 6(B)) in the direction of an arrow T. In this way, the label tape 49 is produced.

Next, a control system of the tape producing apparatus 1 of the first embodiment having the above structure will be described with reference to FIG. 7. FIG. 7 is a block diagram showing the control structure of the tape producing apparatus 1. The keyboard 3, the tape type detecting sensor 34, a display controller (hereinafter referred to as “LCDC”) having a video RAM 59 for outputting display data to the LCD 5, a drive circuit 60 for driving the thermal head 11 and a drive circuit 61 for driving the tape feed motor 36 are connected to an I/O interface 56 of a control unit 57.

The control unit 57 comprises a CPU 50, the I/O interface 56 connected to this CPU 50 through a bus 55 such as data bus, a display character generator ROM (display CGROM) 51, a print character generator ROM (print CGROM) 52, ROM 53 and RAM 54. The display CGROM 51 stores display dot pattern data of predetermined character size regarding a number of characters such as alphabetic letters and symbols. The print CGROM 52 stores print dot pattern data by the quantity of plural print character sizes corresponding to code data of each font regarding the characters such as alphabetic letters and symbols.

The program area of the ROM 53 stores a display drive control program 53a for controlling the LCDC 58 in accordance with the code data of characters such as letters, numbers and symbols inputted through the keyboard 3, a print drive program 53b for transmitting the dot pattern data of each dot column for use in printing to the thermal head 11 successively so as to drive the tape feed motor 36 for print, a divisible tape print processing program 53c for printing on the divisible print tape 22 or the divisible print tape assembly 46 when the divisible tape cassette 21 or 45 particular to the disclosure is detected, a divisible tape transverse print processing program 53d for executing transverse print processing on the divisible print tape 22 or the divisible print tape assembly 46 when the divisible tape cassette 21 or 45 is detected, and a tape-type, tape-width, printable-character-size display and selection processing program 53e for displaying the tape type and tape width of print tape contained in a detected tape cassette and the size of character printable on that tape so as to enable selection by the operator.

The ROM 53 stores font data 53p for use in selecting the font of characters, tape type determining data 53r to be referred to when the above tape-type, tape width, printable-character-size display and selection processing program 53e is executed, and tape-width-printable-character-size data 53s to be referred to when the same tape-type, tape width, printable-character-size display and selection processing program 53e is executed.

Further, the RAM 54 includes a text memory 54a which stores character string data inputted through the keyboard 3, a work memory 54b which stores a result of arithmetic operation in the CPU 50 temporarily, and a buffer 54c.

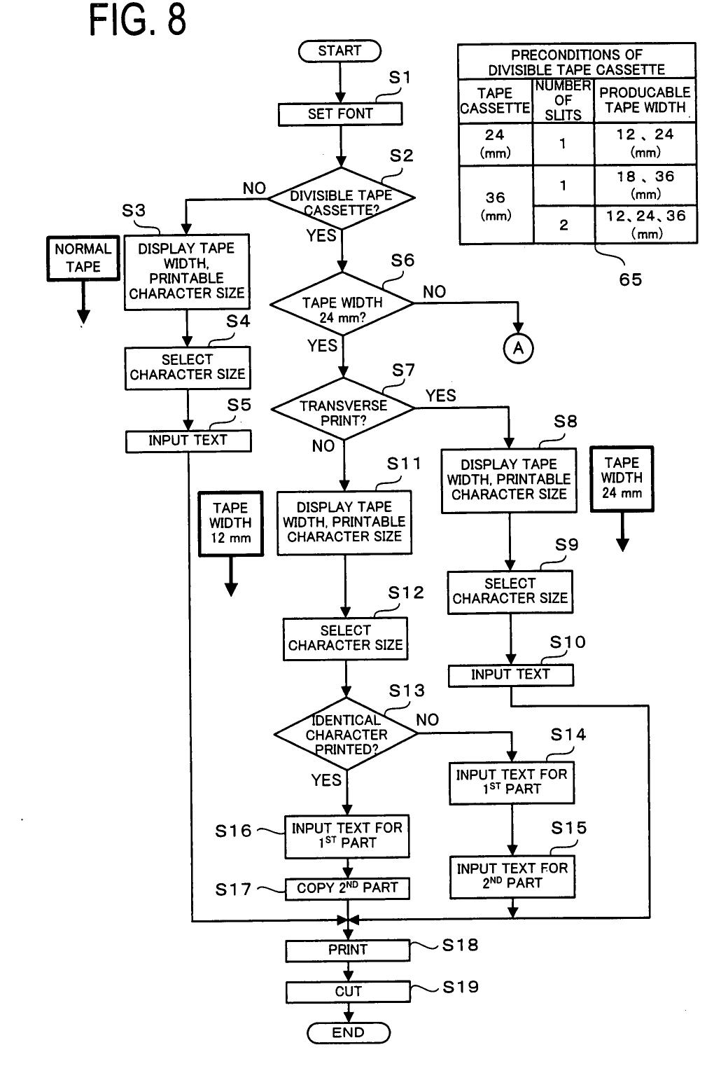

Subsequently, a flow of operation of printing the divisible print tape 22 or the divisible print tape assembly 46 so as to produce the label tape 35 or 49 when the divisible tape cassette 21 or 45 is detected by the tape type detecting sensor 34 of the tape producing apparatus 1 having the above-described structure will be described with reference to FIGS. 8 to 11. In this context, FIGS. 8 to 11 show flow charts for producing the label tape 35 or 49 by printing the divisible print tape 22 or the divisible print tape assembly 46. In the meantime, a step in a drawing of the flow chart is abbreviated as S.

First, the flow chart of FIG. 8 will be described. As indicated in a precondition table 65 of the divisible tape cassette of FIG. 8, it is presumed that the divisible tape cassette 21 or 45 has two types of 24 mm and 36 mm in tape width. In S1, a font for use in producing the label tape 35 or 49 is set. The procedure then proceeds to S2, in which whether a tape cassette set in the tape cassette holding portion 8 of the tape producing apparatus 1 is the divisible tape cassette 21 or 45 is determined. This determination is made in such a manner that the tape type detecting sensor 34 (see FIGS. 2 and 7) placed on the upper right corner of the tape cassette holding portion 8 provided in the main body frame 2 reads information based on a combination of the tape type detecting holes 20 provided in the tape cassette and sends the information to the CPU 50, which makes the above determination. If the tape cassette is not the divisible tape cassette 21 or 45 (S2: NO), the procedure proceeds to S3, in which the procedure enters the process of producing an ordinary label tape. In S3, the tape type and width of the tape cassette set in the tape cassette holding portion 8 and a plurality of sizes of characters printable for that tape width are displayed on the LCD 5.

If the content displayed on the LCD 5 is a desired tape cassette, the procedure then proceeds to S4, in which a black cursor 66 displayed on the LCD 5 is moved to a character size desired by the operator to select from a plurality of the printable character sizes indicated in S3 by using the cursor move key 3b on the keyboard 3 and the desired character size is confirmed with the ENTER key 3a. If the tape cassette is not a desired one, on the other hand, the tape cassette is replaced with the desired one. The procedure then proceeds to S5 in which text such as characters, symbols, and others are inputted into a text memory 54a through the keyboard 3. When the input is completed, the procedure proceeds to S18. In S18, when the print key 3c on the keyboard 3 is pressed, the print drive program 53b is executed to activate the thermal head 11 and the tape feed motor 36 through the drive circuits 60 and 61. Consequently, characters, symbols, and the like inputted in S5 and stored in the text memory 54a are called up from the text memory 54a and printed on the print tape of the tape cassette. Then, the printed print tape is cut out when the cutter button 7 is pressed, thus completing the label tape.

Returning to S2, if the tape cassette is the divisible tape cassette 21 or 45 (S2: YES), the procedure proceeds to S6, in which the procedure enters the process of producing a divisible label tape. In S6, it is determined whether the tape width of the divisible print tape 22 or divisible print tape assembly 46 in the divisible tape cassette 21 or 45 is 24 mm of two types of the tape width prepared. If the tape width of the divisible print tape 22 or the divisible print tape assembly 46 in the divisible tape cassette 21 or 45 is 24 mm (S6: YES), the procedure proceeds to S7, in which it is determined whether or not characters, symbols and others inputted through the keyboard 3 are to be printed across the width (“transverse print”) of the divisible print tape 22 or the divisible print tape assembly 46 in which label tapes are arranged transversely in parallel. If this transverse print is carried out (S7: YES), the procedure proceeds to S8.

In S8, the procedure enters the process of producing the label tape 35 or 49 having a width of 24 mm from the divisible print tape 22 or the divisible print tape assembly 46. In S8, the tape type and size of the cassette tape set in the tape cassette holding portion 8 and plural character sizes printable for that tape width are displayed on the LCD 5. When the content displayed on the LCD 5 is a desired divisible tape cassette 21 or 45, the procedure then proceeds to S9. The black cursor 66 displayed on the LCD 5 is moved to a character size desired by the operator to select from a plurality of the printable character sizes displayed in S8 using the cursor move key 3b on the keyboard 3 and then, that character size is confirmed with the ENTER key 3a.

FIG. 12 shows an example of a display on the LCD 5, displaying the tape type and width of the tape cassette set in the tape cassette holding portion 8 and plural character sizes printable for that tape width. FIG. 12 is an explanatory diagram for explaining a state in which the content of the tape cassette set in the tape cassette holding portion 8 and a selected character size are displayed on the LCD 5. According to FIG. 12, the tape cassette set in the tape cassette holding portion 8 is a divisible tape cassette 21 containing the laminate type divisible print tape 22 having a width of 24 mm and the color of the tape is white while the color of the character is black. The tape width of a portion to be printed is 24 mm when the transverse print is carried out and a printable maximum character size is 55 point (pt.). Further, in FIG. 12, as a desired character size, 48 pt. is selected from the plural printable character sizes. As indicated with a hidden character presence symbol (arrow) 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S10, in which text such as characters, symbols, and others are inputted into the text memory 54a through the keyboard 3. When the input is completed, the procedure proceeds to S18. In S18, the print drive program 53b is started at the press of the print key 3c on the keyboard 3, causing the drive circuits 60 and 61 to operate the thermal head 11 and the tape feed motor 36. Data such characters and symbols stored in the text memory 54a are called up from the text memory 54a and printed on the divisible print tape 22 or the divisible print tape assembly 46 of the divisible tape cassette 21 or 45. Then, the printed print tape is cut when the cutter button 7 is pressed, thus completing the label tape 35 or 49.

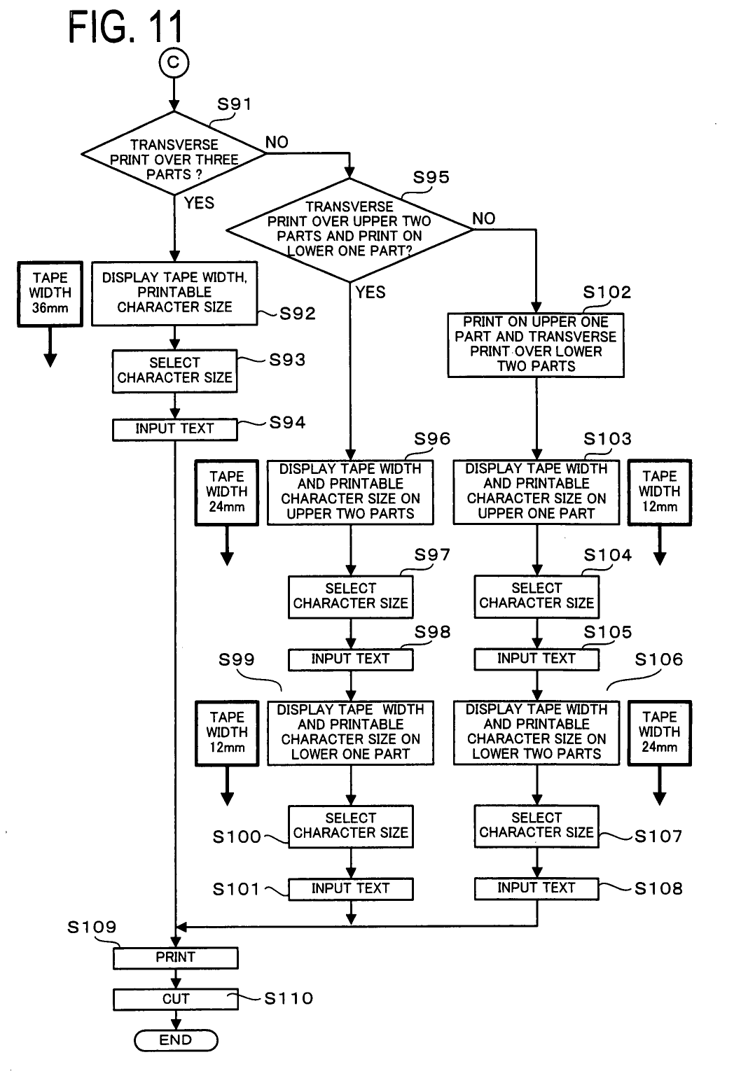

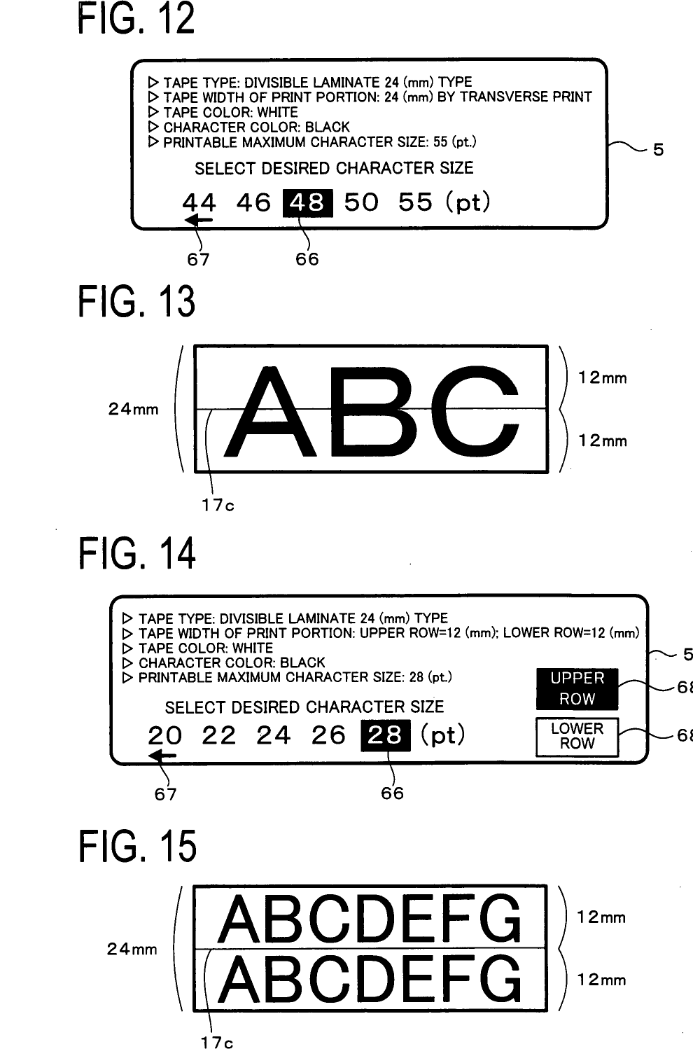

FIG. 13 shows an example of the label tape 35 produced based on the content set in FIG. 12. FIG. 13 is an explanatory diagram for explaining an example of the label tape 35 having a width of 24 mm in which characters are printed striding straddling the slit 17c. As shown in FIG. 13, specifically, with respect to the divisible print tape 22 having a width of 24 mm divisible at the slit 17c into two print tapes each 12 mm in width, characters of 48 pt. size are printed across the width of the divisible print tape 22 including those 12-mm-wide print tapes arranged in parallel. This label tape 35 can be used without being split at the slit 17c, never causing a problem that this print tape is deflected when affixed to any object. The label tapes 35 having a width of 24 mm and a width of 12 mm described later can be produced from one divisible print tape 22. Thus, there is no necessity of preparing many tape cassettes of different tape widths, which is economical.

Returning to S7, if the transverse print is not carried out (S7: NO), the procedure proceeds to S11. In S11, the procedure enters the process of producing two label tapes each having a width of 12 mm arranged transversely in parallel as upper and lower parts from the divisible print tape 22 or the divisible print tape assembly 46 having a width of 24 mm. In S11, the tape type and width of the tape cassette set in the tape cassette holding portion 8 and plural character sizes printable for that tape width are displayed on the LCD 5. If the content displayed on the LCD 5 is a desired divisible tape cassette 21 or 45, the procedure then proceeds to S12. In S12, any one of icons 68 on the LCD 5 representing the upper row and lower row of the label tape to be produced is selected by operating the cursor move key 3b on the keyboard 3. Then, the indicated black cursor 66 is moved to a character size desired by the operator to select from plural printable character sizes displayed in S11 using the cursor move key 3b on the keyboard 3, and that character size is confirmed with the ENTER key 3a. As a result of this operation, character sizes for the upper and lower rows of the label tape are determined.

FIG. 14 shows an example of a display on the LCD 5, displaying the tape type and width of the tape cassette loaded in the tape cassette holding portion 8 and plural character sizes printable for that tape width. FIG. 14 is an explanatory diagram for explaining a state in which the content of the tape cassette set in the tape cassette holding portion 8 and a selected character size are displayed on the LCD 5. According to FIG. 14, the tape cassette set in the tape cassette holding portion 8 is a divisible tape cassette 21 containing the laminate type divisible print tape 22 having a width of 24 mm and the color of the tape is white while the color of the character is black. The tape width of a print portion is 12 mm without the transverse print, indicating that two label tapes each in which a character of 28 pt. in maximum printable character size may be printed can be produced in parallel as the upper and lower rows. Further, in FIG. 12, as a desired character size, 28 pt. is selected from the plural printable character sizes for the upper and lower rows respectively. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S13, in which it is determined whether or not identical characters are to be printed on the label tapes as the upper and lower rows each 12 mm in width in the divisible print tape 22 or the divisible print tape assembly 46 having a width of 24 mm. If identical characters are to be printed on both the upper and lower rows (S13: YES), the procedure proceeds to S16, in which text such as characters, symbols, and others are inputted to a portion of the text memory 54a corresponding to a first print tape (part) located on the upper row through the keyboard 3 and the procedure proceeds to S17. In S17, the memory portion corresponding to the first print tape is copied from the text memory 54a to another portion of the text memory 54a corresponding to a second print tape (part) located on the lower row. When the copy is completed, the procedure then proceeds to S18. In S18, the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S16 and S17 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

FIG. 15 shows an example of the label tape 35 produced based on the content set in FIG. 14. FIG. 15 is an explanatory diagram for explaining an example that identical characters are printed on print tapes arranged in parallel forming the label tape 35 having a width of 24 mm. As shown in FIG. 15, characters of 28 pt. size are printed on the print tapes each having a width of 12 mm arranged in parallel in the divisible print tape 22 having a width of 24 mm, which can be split at the slit 17c into the print tapes 12 mm in width. Since the divisible print tapes 22 have an easy splitting property at a portion corresponding to the slit 17c, the label tape 35 can be split easily with hands without use of scissors or the like before use. Thus, double tapes can be produced by a single operation. Specifically, the label tapes 35 having a width of 24 mm and a width of 12 mm can be produced from the divisible print tape 22, so that there is no necessity of preparing many tape cassettes of different tape widths, which is economical.

Returning to S13, if identical characters are not to be printed on the upper and lower rows (S13: NO), the procedure proceeds to S14. In S14, characters, symbols and others are inputted to a portion of the text memory 54a corresponding to a first print tape (part) located on the upper row and the procedure proceeds to S15. In S15, characters, symbols and others are inputted to another portion of the text memory 54a corresponding to a second print tape (part) located on the lower row and the procedure proceeds to S18. In S18, the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S14 and S15 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

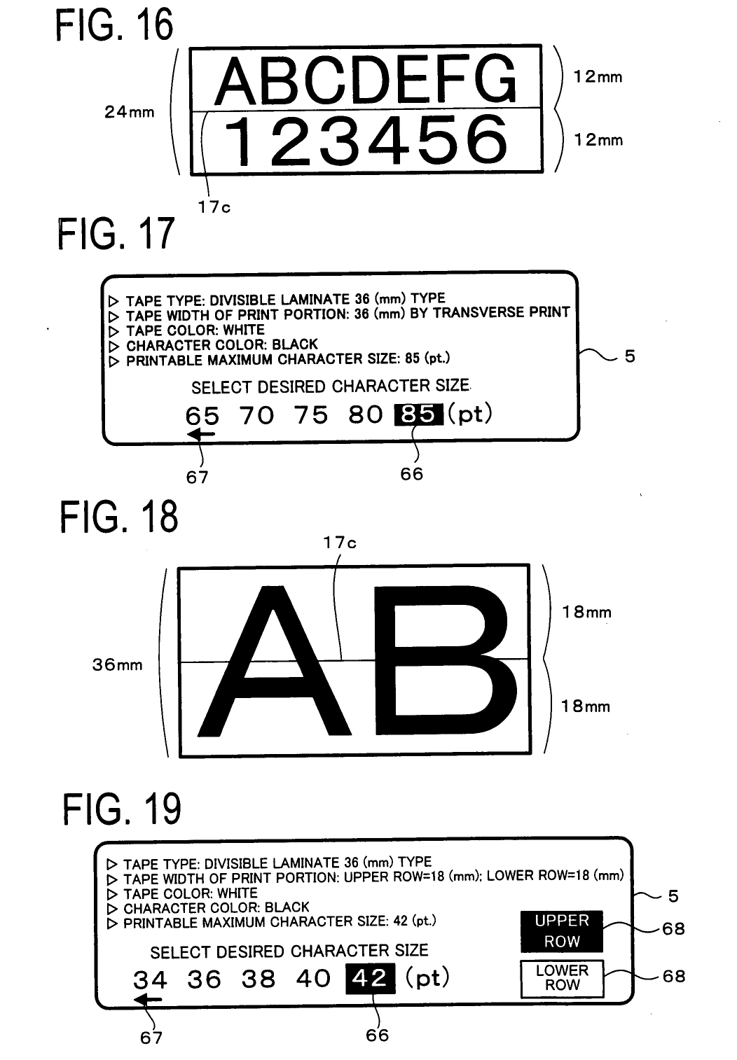

FIG. 16 shows an example of the label tape 35 produced based on the content set in FIG. 14. FIG. 16 is an explanatory diagram for explaining an example that different characters are printed on print tapes arranged in parallel of the label tape 35 having a width of 24 mm. As shown in FIG. 16, characters of 28 pt. size are printed on the print tapes each having a width of 12 mm arranged in parallel in the divisible print tape 22 having a width of 24 mm, which can be split at the slit 17c into the print tapes each 12 mm in width. The divisible print tape 22 has an easy splitting property at a portion corresponding to the slit 17c, so that the label tape 35 can be split easily with hands without use of scissors or the like before use. Thus, double tapes can be produced by a single operation. Specifically, the label tapes 35 having a width of 24 mm and a width of 12 mm can be produced from the divisible print tape 22, so that there is no necessity of preparing tape cassettes of different tape widths, which is economical.

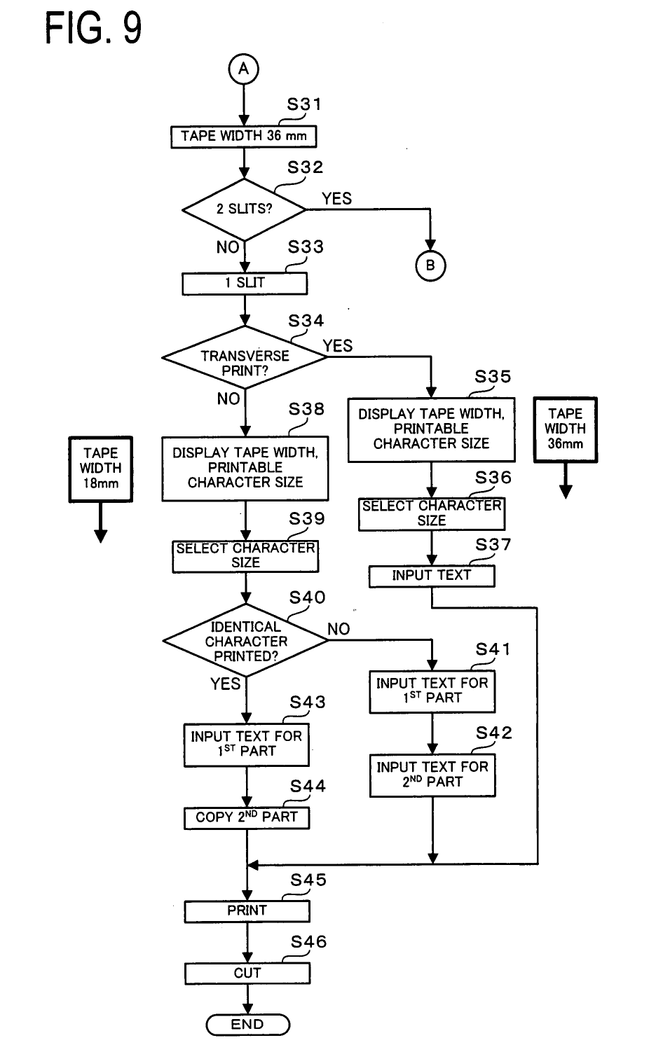

Returning to S6, if the tape width of the divisible print tape 22 or the divisible print tape assembly 46 of the divisible tape cassette 21 or 45 is not 24 mm (S6: NO), it is found that the tape width is 36 mm from the precondition table 65 of the divisible tape cassette of FIG. 8 and then, the procedure proceeds to S31 in FIG. 9. In S31, it is verified that the tape width of the divisible print tape 22 or the divisible print tape assembly 46 of the divisible tape cassette 21 or 45 is 36 mm and the procedure proceeds to S32.

In S32, it is determined whether or not two slits 17c for use in dividing exist in the divisible print tape 22 or the divisible print tape assembly 46 of the divisible tape cassette 21 or 45. If two adhesive base material slits 17c for use in dividing do not exist (S32: NO), it is apparent from the precondition table 65 of the divisible tape cassette of FIG. 8 that only a single slit 17c exists. Then, the procedure proceeds to S33, in which it is found that only the slit 17c for use in dividing exists in the divisible print tape 22 or the divisible print tape assembly 46 of the divisible tape cassette 21 or 45 and two label tapes each 18 mm in width can be produced by dividing the label tape 35 or 49 having a width of 36 mm at the slit 17c. Then, the procedure proceeds to S34.

In S34, subsequently, it is determined whether or not characters, symbols and others inputted through the keyboard 3 are to be printed across the width (“transverse print”) of the divisible print tape 22 or the divisible print tape assembly 46 in which print tapes are arranged transversely in parallel. If the transverse print is carried out (S34: YES), the procedure proceeds to S35.

In S35, the procedure enters the process of producing the label tape 35 or 49 each having a width of 36 mm from the divisible print tape 22 or the divisible print tape assembly 46. In S35, the tape type and width of the tape cassette set in the tape cassette holding portion 8 and plural character sizes printable for that tape width are displayed on the LCD 5. If the content displayed on the LCD 5 is a desired divisible tape cassette 21 or 45, the procedure then proceeds to S36. In S36, the black cursor 66 appearing on the LCD is moved to a character size desired by the operator using the cursor move key 3b on the keyboard 3 to select from plural printable character sizes displayed in S35, and the character size is confirmed with the ENTER key 3a.

FIG. 17 shows an example of a display on the LCD 5, displaying the tape type and width of the tape cassette set in the tape cassette holding portion 8 and plural character sizes printable for that tape width. FIG. 17 is an explanatory diagram for explaining a state in which the content of the tape cassette set in the tape cassette holding portion 8 and a selected character size are displayed on the LCD 5. According to FIG. 17, the tape cassette set in the tape cassette holding portion 8 is a divisible tape cassette 21 containing the laminate type divisible print tape 22 having a width of 36 mm and the color of the tape is white while the color of the character is black. The tape width of a print portion is 36 mm without the transverse print, indicating that the printable maximum character size is 85 pt. Further, in FIG. 17, as a desired character size, 85 pt. is selected from the plural printable character sizes. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S37, in which text such as characters, symbols, and others are inputted into the text memory 54a through the keyboard 3. When the input is completed, the procedure proceeds to S45. In S45, the print drive program 53b is started by pressing the print key 3c on the keyboard 3 to operate the thermal head 11 and the tape feed motor 36 through the drive circuits 60 and 61. Data such characters and symbols stored in the text memory 54a are called up from the text memory 54a and printed on the divisible print tape 22 or the divisible print tape assembly 46 of the divisible tape cassette 21 or 45. Then, the printed print tape is cut when the cutter button 7 is pressed, completing the label tape 35 or 49.

FIG. 18 shows an example of the label tape 35 produced based on the content set in FIG. 17. FIG. 18 is an explanatory diagram for explaining an example of the label tape 35 having a width of 36 mm in which characters are printed straddling the slit 17c. As shown in FIG. 18, specifically, with respect to the divisible print tape 22 of a width of 36 mm which can be split at the slit 17c into two print tapes each 18 mm in width, characters of 85 pt. size are printed across the tape width of the divisible print tape 22 including the 18-mm-wide print tapes arranged in parallel. This label tape 35 can be used without being split at the slit 17c, never causing a problem that this print tape is deflected when affixed to any object. The label tapes 35 having a width of 36 mm and a width of 18 mm described later can be produced from one divisible print tape 22, so that there is no necessity of preparing many tape cassettes of different tape widths, which is economical.

Returning to S34, if the transverse print is not carried out (S34: NO), the procedure proceeds to S38. In S38, the procedure enters the process of producing two label tapes each having a width of 18 mm arranged transversely in parallel as upper and lower parts from the divisible print tape 22 or the divisible print tape assembly 46 having a width of 36 mm. In S38, the tape type and width of the tape cassette set in the tape cassette holding portion 8 and plural character sizes printable for that tape width are displayed on the LCD 5. If the content displayed on the LCD 5 is a desired divisible tape cassette 21 or 45, the procedure then proceeds to S39, in which any one of icons 68 representing the upper row and lower row of the label tape to be produced is selected by operating the cursor move key 3b on the keyboard 3. The black cursor 66 is moved to a character size desired by the operator using the cursor move key 3b on the keyboard 3 to select from plural printable character sizes displayed in S38 and then that character size is confirmed with the ENTER key 3a. As a result of this operation, respective character sizes for the upper and lower rows of the label tape are determined.

FIG. 19 shows an example of a display on the LCD 5, displaying the tape type and width of the tape cassette set in the tape cassette holding portion 8 and plural character sizes printable for that tape width. FIG. 19 is an explanatory diagram for explaining a state in which the content of the tape cassette set in the tape cassette holding portion 8 and a selected character size are displayed on the LCD 5. According to FIG. 19, the tape cassette set in the tape cassette holding portion 8 is a divisible tape cassette 21 containing the laminate type divisible print tape 22 having a width of 36 mm and the color of the tape is white while the color of the character is black. The tape width of a print portion is 18 mm without the transverse print, indicating that two label tapes each in which a character of 42 pt. in maximum printable character size may be printed can be produced in parallel as the upper and lower rows. Further, in FIG. 19, as a desired character size, 42 pt. is selected from the plural printable character sizes for the upper and lower rows. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S40, in which it is determined whether or not identical characters are to be printed on the label tapes as the upper and lower rows each 18 mm in width in the divisible print tape 22 or the divisible print tape assembly 46 having a width of 36 mm. If identical characters are to be printed on both the upper and lower rows (S40: YES), the procedure proceeds to S43, in which characters, symbols and others are inputted to a portion of the text memory 54a corresponding to a first print tape (part) located on the upper row through the keyboard 3 and the procedure proceeds to S44. In S44, the memory portion corresponding to the first print tape is copied from the text memory 54a to another portion of the text memory 54a corresponding to a second print tape (part) located on the lower row. When the copy is completed, the procedure proceeds to S45 in which the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S43 and S44 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

FIG. 20 shows an example of the label tape 35 produced based on the content set in FIG. 19. FIG. 20 is an explanatory diagram for explaining an example that identical characters are printed on print tapes arranged in parallel of the label tape 35 having a width of 36 mm. As shown in FIG. 20, characters of 42 pt. size are printed on the print tapes each having a width of 18 mm arranged in parallel in the divisible print tape 22 having a width of 36 mm, which can be split at the slit 17c into the print tapes 18 mm in width. The divisible print tape 22 has the easy splitting property at a portion corresponding to the slit 17c, so that the label tape 35 can be split easily with hands without use of scissors or the like before use. Double tapes can be produced by a single operation and therefore this is suitable for producing the identical tapes in a large quantity. The label tapes 35 having a width of 24 mm and a width of 12 mm can be produced from the divisible print tape 22, so that there is no necessity of possessing tape cassettes of multiple tape widths, which is economical.

Returning to S40, if identical characters are not to be printed on the upper and lower rows (S40: NO), the procedure proceeds to S41. In S41, characters, symbols and others are inputted to a portion of the text memory 54a corresponding to a first print tape (part) located on the upper row and the procedure proceeds to S42. In S42, characters, symbols and others are inputted to another portion of the text memory 54a corresponding to a second print tape (part) located on the lower row and the procedure proceeds to S45. In S45, the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S41 and S42 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

FIG. 21 shows an example of the label tape 35 produced based on the content set in FIG. 19. FIG. 21 is an explanatory diagram for explaining an example that different characters are printed on print tapes arranged in parallel of the label tape 35 having a width of 36 mm. As shown in FIG. 21, characters of 42 pt. size are printed on the print tapes each having a width of 18 mm arranged in parallel in the divisible print tape 22 having a width of 36 mm, which can be split at the slit 17c into the print tapes each 18 mm in width. The divisible print tape 22 has the easy splitting property at the portion corresponding to the slit 17c, so that the label tape 35 can be split easily with hands without use of scissors or the like before use. In this way, double tapes can be produced by a single operation. The label tapes 35 having a width of 36 mm and a width of 18 mm can be produced from the divisible print tape 22, so that there is no necessity of possessing tape cassettes of multiple tape widths, which is economical.

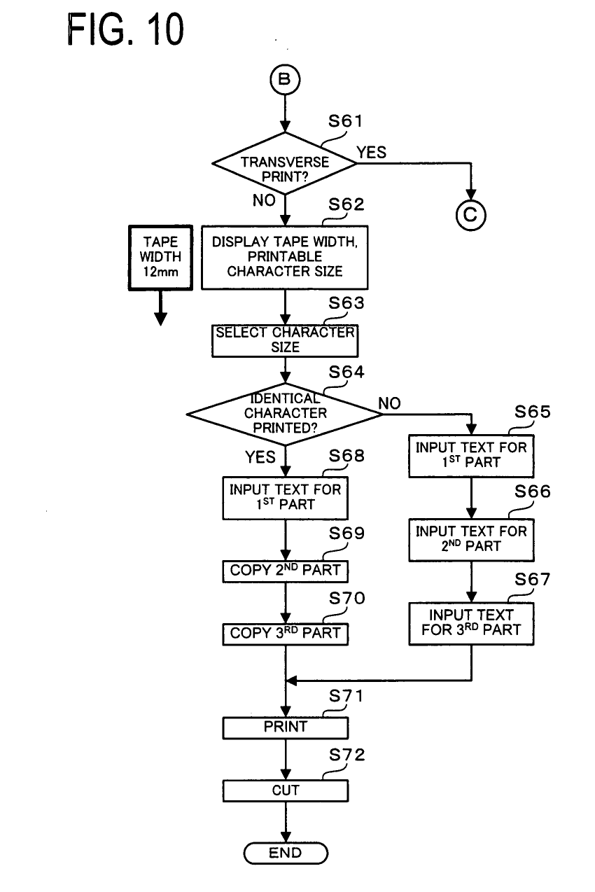

Returning to S32, if two slits 17c for use in dividing exist (S32: YES), the procedure proceeds to S61 in FIG. 10. Because the two slits 17c exist, three label tapes having a width of 12 mm can be produced as upper row, middle row and lower row relative to the divisible print tape 22 or the divisible print tape assembly 46 having a width of 36 mm. In S61, it is determined whether or not characters, symbols and others inputted through the keyboard 3 are to be printed transversely across the tape width of the divisible print tape 22 or the divisible print tape assembly 46 including tapes arranged transversely in parallel as the upper, middle and lower rows. If the transverse print is not to be carried out (S61: NO), the procedure proceeds to S62 to enter the process of producing three label tapes each 12 mm in width in parallel as the upper, middle and lower rows from the divisible print tape 22 or the divisible print tape assembly 46. In S62, the tape type and width of the tape cassette set in the tape cassette holding portion 8 and plural character sizes printable on that width are displayed on the LCD 5.

If the content displayed on the LCD 5 is a desired divisible tape cassette 21 or 45, the procedure then proceeds to S63. Icons 68 representing the upper row, middle row, and lower row of the label tape to be produced are displayed on the LCD 5. Each row is selected by operating the cursor move key 3b on the keyboard 3. The indicated black cursor 66 is moved to a character size desired by the operator using the cursor move key 3b on the keyboard 3 to select from plural printable character sizes displayed in S62 and then the character size is confirmed with the ENTER key 3a. As a result of this operation, the character sizes for the upper, middle and lower rows of the label tape to be produced are determined.

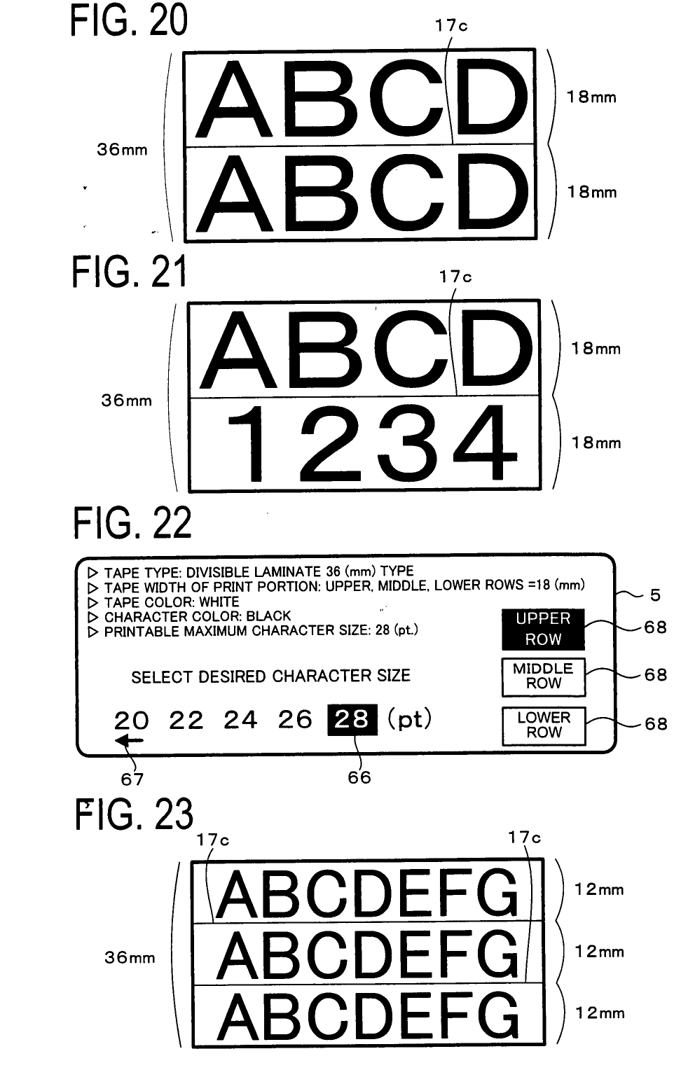

FIG. 22 shows an example of a display on the LCD 5, displaying the tape type and width of the tape cassette set in the tape cassette holding portion 8 and plural character sizes printable for that tape width. FIG. 22 is an explanatory diagram for explaining a state in which the content of the tape cassette set in the tape cassette holding portion 8 and a selected character size are displayed on the LCD 5. According to FIG. 22, the tape cassette set in the tape cassette holding portion 8 is the divisible tape cassette 21 containing the laminate type divisible print tape 22 having a width of 36 mm and the color of the tape is white while the color of the character is black. The tape width of a print portion is 12 mm without the transverse print, indicating that three label tapes each in which a character of 28 pt. in maximum printable character size may be printed can be produced in parallel as the upper, middle and lower rows. Further, in FIG. 19, as a desired character size, 42 pt. is selected from the plural printable character sizes for the upper and lower rows. Further, in FIG. 22, a character size of 28 pt. is selected for the upper, middle and lower rows as a desired character size from the plural printable character sizes. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S64, in which it is determined whether or not identical characters are to be printed on the label tapes as the upper, middle and lower rows each 12 mm in width in the divisible print tape 22 or the divisible print tape assembly 46 having a width of 36 mm. If identical characters are to be printed on all the upper, middle and lower rows (S64: YES), the procedure proceeds to S68, in which characters, symbols and others are inputted to a portion of the text memory 54a corresponding to a first print tape (part) located on the upper row through the keyboard 3 and the procedure proceeds to S69. In S69, the memory portion corresponding to the first print tape is copied from the text memory 54a to another portion of the text memory 54a corresponding to a second print tape (part) located on the middle row. When the copy is completed, the procedure proceeds to S70. In S70, the memory portion corresponding to the first print tape is copied from the text memory 54a to another portion of the text memory 54a corresponding to a third print tape (part) located on the lower row. When the copy is completed, the procedure proceeds to S71 in which the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S68, S69, and S70 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

FIG. 23 shows an example of the label tape 35 produced based on the content set in FIG. 22. FIG. 23 is an explanatory diagram for explaining an example that identical characters are printed on print tapes arranged in parallel as the upper, middle and lower rows of the label tape 35 having a width of 36 mm. As shown in FIG. 23, specifically, with respect to the divisible print tape 22 having a width of 36 mm divisible at the two slits 17c to the print tapes each 12 mm in width, characters of 28 pt. size are printed on those 12-mm-wide print tapes arranged in parallel as the upper, middle and lower rows. The divisible print tape 22 has the easy splitting property at the portion corresponding to the slits 17c, so that the label tape 35 can be split easily with hands without use of scissors or the like before use. Double tapes can be produced by a single operation and therefore this is suitable for producing the identical tapes in a large quantity. The label tapes 35 having a width of 36 mm and a width of 24 mm can be produced from the divisible print tape 22, so that there is no necessity of preparing many tape cassettes of different tape widths, which is economical.

Returning to S64, if identical characters are not printed on the upper, middle and lower rows (S64: NO), the procedure proceeds to S65. In S65, characters, symbols and others are inputted to a portion of the text memory 54a corresponding to a first print tape (part) located on the upper row and the procedure proceeds to S66. In S66, characters, symbols and others are inputted to another portion of the text memory 54a corresponding to a second print tape (part) located on the middle row and the procedure proceeds to S67. In S67, characters, symbols and others are inputted to another portion of the text memory 54a corresponding to a third print tape (part) located on the lower row and the procedure proceeds to S71. In S71, the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S65, S66 and S67 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

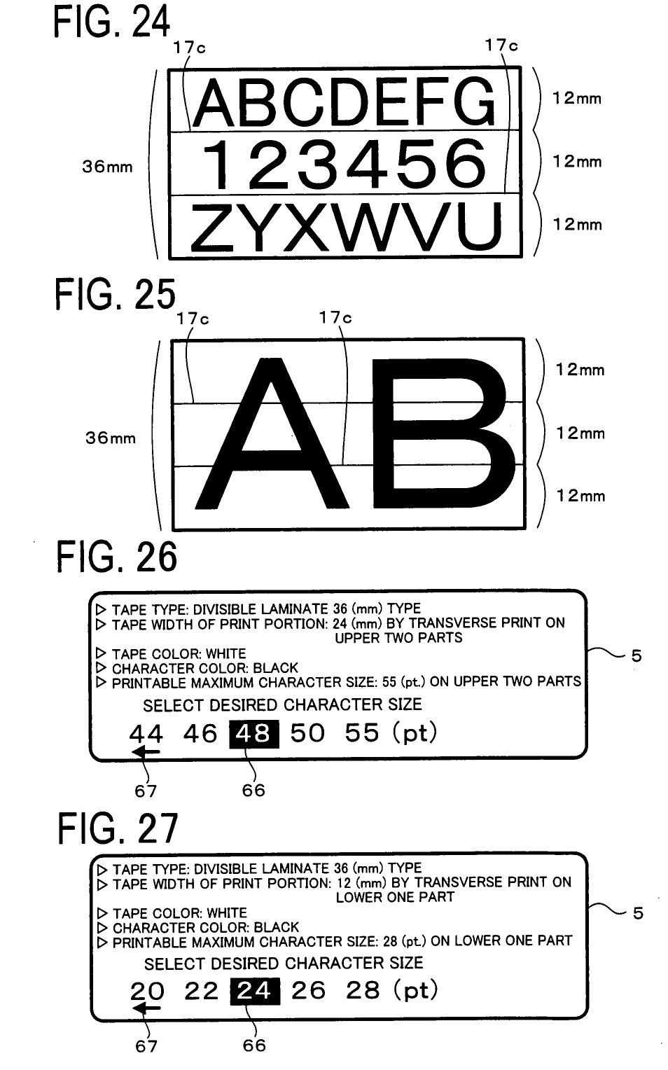

FIG. 24 shows an example of the label tape 35 produced based on the content set in FIG. 22. FIG. 24 is an explanatory diagram for explaining an example that different characters are printed on print tapes arranged in parallel as the upper, middle and lower rows of the label tape 35 having a width of 36 mm. As shown in FIG. 24, specifically, with respect to the divisible print tape 22 having a width of 36 mm divisible at the two slits 17c into the print tapes each 12 mm in width, characters of 28 pt. size are printed on those print tapes each 12 mm in width arranged in parallel as the upper, middle and lower rows. The divisible print tape 22 has the easy splitting property at the portion corresponding to the slits 17c, so that the label tape 35 can be split easily with hands without use of scissors or the like before use. In this way, triple tapes can be produced by a single operation. The label tapes 35 having a width of 36 mm and a width of 24 mm can be produced from the divisible print tape 22, so that there is no necessity of preparing many tape cassettes of different tape widths, which is economical.

Returning to S61, if the transverse print is to be carried out (S61: YES), the procedure proceeds to S91 in FIG. 11. In S91, it is determined whether or not characters, symbols and others inputted through the keyboard 3 are to be printed over three tapes arranged in parallel as the upper, middle and lower rows of the divisible print tape 22 or the divisible print tape assembly 46. If the three tapes of the upper, middle and lower rows are to be printed across the total tape width (S91: YES), the procedure proceeds to S92.

In S92, the procedure enters the process of producing the label tape 35 or 49 having a width of 36 mm and having two slits 17c from the divisible print tape 22 or the divisible print tape assembly 46. In S92, the type and size of a cassette tape set in the tape cassette holding portion 8 and plural character sizes printable for that tape width are displayed on the LCD 5. When the content displayed on the LCD 5 is a desired divisible tape cassette 21 or 45, the procedure proceeds to S93. The black cursor 66 displayed on the LCD 5 is moved to a character size desired by the operator to select from a plurality of the printable character sizes displayed in S92 using the cursor move key 3b on the keyboard 3 and then that character size is confirmed with the ENTER key 3a.

On the other hand, if the loaded tape cassette is not a desired one, it is replaced with the desired divisible tape cassette 21 or 45.

Subsequently, the procedure proceeds to S94, in which text such as characters, symbols, and others are inputted into the text memory 54a through the keyboard 3. When the input is completed, the procedure proceeds to S109 in which the print drive program 53b is started by pressing the print key 3c on the keyboard 3 to operate the thermal head 11 and the tape feed motor 36 through the drive circuits 60 and 61. Data such characters and symbols stored in the text memory 54a are called up from the text memory 54a and printed on the divisible print tape 22 or the divisible print tape assembly 46 of the divisible tape cassette 21 or 45. Then, the printed print tape is cut when the cutter button 7 is pressed, completing the label tape 35 or 49.

FIG. 25 shows an example of the label tape 35 produced based on the content set in FIG. 17. FIG. 25 is an explanatory diagram for explaining an example of the label tape 35 having a width of 36 mm in which characters are printed straddling the two slits 17c. As shown in FIG. 25, specifically, with respect to the divisible print tape 22 having a width of 36 mm divisible at the two slits 17c into three print tapes each 12 mm in width, characters of 85 pt. size are printed on those print tapes each 12 mm in width arranged in parallel. This label tape 35 can be used without being split at the slits 17c, never causing a problem that this print tape is deflected when affixed to any object. The label tapes 35 having a width of 36 mm and a width of 24 mm described later can be produced from one divisible print tape 22, so that there is no necessity of preparing many tape cassettes of different tape widths, which is economical.

Returning to S91, if the transverse print is not to be carried out on the three tapes of the upper, middle, and lower rows (S91: NO), the procedure proceeds to S95. The divisible print tape 22 or the divisible print tape assembly 46 having a width of 36 mm divisible at the two slits 17c into three label tapes each 12 mm in width after printed can produce a label tape 24 mm in width depending on a combination. Thus, it is determined whether or not the transverse print on upper two rows and the print on the lower row are to be intended. If the transverse print on the upper two rows and the print on the lower one are to be performed, the procedure proceeds to S96 to enter the process of producing a label tape having a width of 24 mm using two tapes of the upper and middle rows of the divisible print tape 22 or the divisible print tape assembly 46 and a label tape having a width of 12 mm using a single tape of the lower row. In S96, the type of a tape in the tape cassette set in the tape cassette holding portion 8, total width of the upper two tapes and plural character sizes printable for that tape width are displayed on the LCD 5. If the content displayed on the LCD 5 is a desired divisible tape cassette 21 or 45, the procedure then proceeds to S97, in which the black cursor 66 displayed on the LCD 5 is moved to a character size desired by the operator using the cursor move key 3b on the keyboard 3 to select from the plural printable character sizes displayed in S96, and the character size is confirmed with the ENTER key 3a.

FIG. 26 shows an example of a display on the LCD 5, displaying the tape type and width of the tape cassette set in the tape cassette holding portion 8 and plural character sizes printable for that tape width. FIG. 26 is an explanatory diagram for explaining a state in which the content of the tape cassette set in the tape cassette holding portion 8 and a selected character size are displayed on the LCD 5. According to FIG. 26, the tape cassette set in the tape cassette holding portion 8 is a divisible tape cassette 21 containing the laminate type divisible print tape 22 having a width of 36 mm and the color of the tape is white while the color of the character is black. The tape width of the print portion on the upper two rows for the transverse print is 24 mm in width, and the printable maximum character size therein is 55 pt. Further, in FIG. 26, as a desired character size, 48 pt. is selected from the plural printable character sizes. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S98, in which characters, symbols and others are inputted through the keyboard 3 into the text memory 54a for the upper two rows of the print tape. When the input is completed, the procedure proceeds to S99.

In S99, subsequently, the type of a tape in the tape cassette set in the tape cassette holding portion 8, the width of a tape on a lower row and plural character sizes printable for that tape width are displayed on the LCD 5. If the content displayed on the LCD 5 is a desired divisible tape cassette 21 or 45, the procedure then proceeds to S100, in which the black cursor displayed on the LCD 5 is moved to a character size desired by the operator using the cursor move key 3b on the keyboard 3 to select from plural printable character sizes displayed in S99, and the character size is confirmed with the ENTER key 3a.

FIG. 27 shows an example of a display on the LCD 5, displaying the tape type and width of the tape cassette set in the tape cassette holding portion 8 and plural character sizes printable for that tape width. FIG. 27 is an explanatory diagram for explaining a state in which the content of the tape cassette set in the tape cassette holding portion 8 and a selected character size are displayed on the LCD 5. According to FIG. 27, the tape cassette set in the tape cassette holding portion 8 is a divisible tape cassette 21 containing the laminate type divisible print tape 22 having a width of 36 mm and the color of the tape is white while the color of the character is black. The tape width of a print portion on a lower row is 12 mm and its printable maximum character size is 28 pt. Further, in FIG. 27, a character size of 24 pt. is selected as a desired character size from the plural printable character sizes. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

Then, the procedure proceeds to S101, in which characters, symbols and others are inputted through the keyboard 3 into the text memory 54a for the lower row of the print tape. When the input is completed, the procedure proceeds to S109.

In S109, subsequently, the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S98 and S101 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

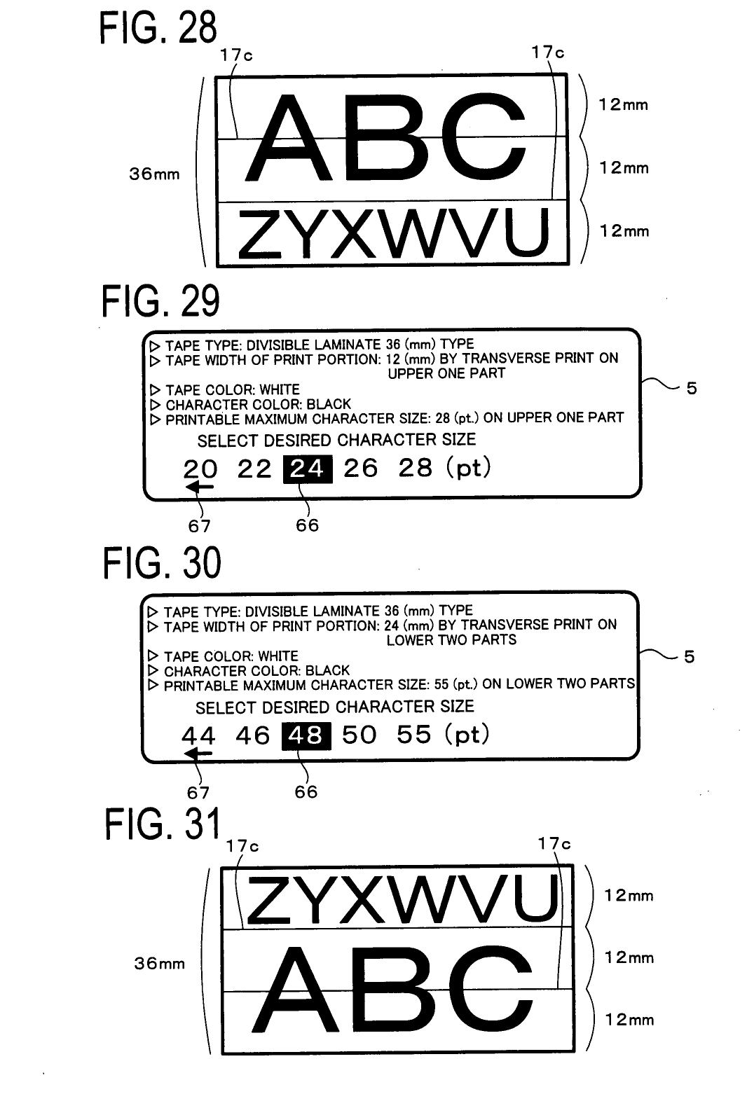

FIG. 28 shows an example of the label tape 35 produced based on the content set in FIGS. 26 and 27. FIG. 28 is an explanatory diagram for explaining a label tape 35 having a width of 36 mm in which characters are printed on upper two tapes of the divisible print tape straddling the slit 17c while characters are printed on a lower row. As shown in FIG. 28, specifically, with respect to the divisible print tape 22 of a width of 36 mm, which is divisible at the two slits 17c into three tapes 12 mm in width, characters of 55 pt. size are printed transversely across the width of two tapes each 12 mm in width arranged in parallel as the upper row and middle row of the divisible print tape 22. The divisible print tape 22 has the easy splitting property at the portion corresponding to the slit 17c between the middle row and the lower row, so that the label tape 35 can be split easily with hands without use of scissors or the like before use. Thus, this label tape 35 can be used for objects which make a pair as a large size and a small size.

Returning to S95, if the transverse print of the upper two rows and the print of the lower row are not to be carried out (S95: NO), the procedure proceeds to S102 to enter the process of producing a label tape 24 mm in width using two tapes of the middle and lower rows of the divisible print tape 22 or the divisible print tape assembly 46 and a label tape 12 mm in width using a tape of the upper row. In S103, the type of a tape in the tape cassette set in the tape cassette holding portion 8, the total width of the lower two tapes and plural printable character sizes are displayed on the LCD 5. If the content displayed on the LCD 5 is a desired divisible tape cassette 21 or 45, the procedure then proceeds to S104, in which the black cursor 66 indicated on the LCD 5 is moved to a character size desired by the operator using the cursor move key 3b on the keyboard 3 to select from the plural printable character sizes displayed in S103, and the character size is confirmed with the ENTER key 3e.

FIG. 29 shows an example of a display on the LCD 5, displaying the tape type and width of the tape cassette set in the tape cassette holding portion 8 and plural character sizes printable for that tape width. FIG. 29 is an explanatory diagram for explaining a state in which the content of the tape cassette set in the tape cassette holding portion 8 and a selected character size are displayed on the LCD 5. According to FIG. 29, the tape cassette set in the tape cassette holding portion 8 is a divisible tape cassette 21 containing the laminate type divisible print tape 22 having a width of 36 mm and the color of the tape is white while the color of the character is black. The tape width of a print portion on an upper row is 12 mm and its printable maximum character size is 28 pt. Further, in FIG. 29, as a desired character size, 28 pt. is selected from the plural printable character sizes as a desired character size. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S105, in which characters, symbols and others are inputted into the text memory 54a for the upper row of the print tape through the keyboard 3. When the input is completed, the procedure proceeds to S106.

In S106, subsequently, the type of a tape in the tape cassette set in the tape cassette holding portion 8, the total width for the lower two rows and plural character sizes printable for that tape width are displayed on the LCD 5. If the content displayed on the LCD 5 is a desired divisible tape cassette 21 or 45, the procedure then proceeds to S107, in which the black cursor displayed on the LCD 5 is moved to a character size desired by the operator using the cursor move key 3b on the keyboard 3 to select from plural printable character sizes displayed in S106, and the character size is confirmed with the ENTER key 3a.

FIG. 30 shows an example of a display on the LCD 5, displaying the tape type and width of the tape cassette set in the tape cassette holding portion 8 and plural character sizes printable for that tape width. FIG. 30 is an explanatory diagram for explaining a state in which the content of the tape cassette set in the tape cassette holding portion 8 and a selected character size are displayed on the LCD 5. According to FIG. 30, the tape cassette set in the tape cassette holding portion 8 is a divisible tape cassette 21 containing the laminate type divisible print tape 22 having a width of 36 mm and the color of the tape is white while the color of the character is black. The width of a print portion on the lower two rows for the transverse print is 24 mm and the printable maximum character size therein is 55 pt. Further, in FIG. 30, a character size of 55 pt. is selected as a desired character size from the plural printable character sizes. As indicated with a hidden character presence symbol 67, representing that smaller character sizes are hidden, the smaller character sizes can also be selected by using the cursor move key 3b on the keyboard 3.

On the other hand, if a loaded tape cassette is not a desired tape cassette, it is replaced with the desired divisible tape cassette 21 or 45.

The procedure then proceeds to S108, in which characters, symbols and others are inputted through the keyboard 3 into the text memory 54a for the lower two rows of the print tape. When the input is completed, the procedure proceeds to S109.

In S109, subsequently, the print drive program 53b is executed by pressing the print key 3c on the keyboard 3 to operate the thermal head 11 and the tape feed motor 36 through the drive circuits 60 and 61. Consequently, characters, symbols and others stored in the text memory 54a in S105 and S108 are called up from the text memory 54a and printed on the divisible print tape 22 or the divisible print tape assembly 46 of the divisible tape cassette 21 or 45. Then, the printed print tape is cut out when the cutter button 7 is pressed, completing the label tape 35 or 49.

FIG. 31 shows an example of the label tape 35 produced based on the content set in FIGS. 29 and 30. FIG. 31 is an explanatory diagram for explaining a label tape 35 having a width of 36 mm in which characters are printed on an upper part of the divisible print tape while characters are printed on the two lower rows straddling the slit 17c. As shown in FIG. 31, specifically, with respect to the divisible print tape 22 having a width of 36 mm divisible at the two slits 17c into three tapes 12 mm in width, characters of 28 pt. size are printed on an uppermost tape 12 mm in width. Then, characters of 55 pt. size are printed across the width of the two lower tapes each 12 mm in width on the middle and lower rows arranged in parallel. The divisible print tape 22 has the easy splitting property at the portion corresponding to the slit 17c between the upper row and the middle row, so that the label tape 35 can be split easily with hands without use of scissors or the like before use. Thus, this label tape 35 can be used for objects which make a pair as a large size and a small size.

As described in detail above, the print member 38 of the first embodiment is constituted of the divisible print tape assembly 46 in which the divisible print tape 22 and the divisible double-sided adhesive tape 24 are bonded to each other preliminarily, in which the ink 23a is to be applied to the surface of the divisible print tape 22 so as to print characters or symbols. The adhesive base material 17 which constitutes the divisible double-sided adhesive tape 24 has the slit 17c perpendicular to the width direction of the divisible double-sided adhesive tape 24 and the divisible print tape 22 has the easy splitting property which allows itself to be split easily in the same direction as the slit 17c in the adhesive base material 17. Characters are printed on the upper and lower parts of the divisible print tape 22 on both sides of the slit 17c as a boundary, and the printed divisible tape 22 is split along the slit 17c in the adhesive base material 17 by utilizing the easy splitting property in the same direction as the slit 17c so as to produce printed tapes. As a result, at least double printed tapes can be produced from the divisible print tape assembly 46. Further, the divisible print tape 22 can be split easily with hands without use of scissors because it has the easy splitting property. Further, the adhesive base material 17 which constitutes the divisible double-sided adhesive tape 24 serves as a reinforcing member in reliably splitting the divisible print tape 22 at the slit 17c provided in the adhesive base material 17, so that the divisible print tape 22 can be prevented from being split at other portion than the slit 17c in the adhesive base material 17.

On the other hand, if characters and others are printed on the tape across its total width, the divisible print tape 22 may be affixed as a single integral tape without being divided. This makes it possible to solve such a problem that after characters and others are printed on an entire print tape having the slit, printed characters may be deflected from each other when the tape divided into separate tapes at the slit and those tapes are affixed in combination.

With this divisible print tape 22, it is possible to produce printed tapes having different tape widths from a single divisible print tape assembly 46. This makes it possible to eliminate inconvenience of replacing the print tape to another one having a desired width to be produced.

The print medium 38 comprises the divisible print tape 22 and the divisible double-sided adhesive tape 24, in which after the ink 23a is applied to the surface of the divisible print tape 22 so as to print characters and others, its printed face and the divisible double-sided adhesive tape 24 are bonded to each other. The adhesive base material 17 which constitutes the divisible double-sided adhesive tape 24 has the slit 17c perpendicular to the width direction of the divisible double-sided adhesive tape 24. In addition to the aforementioned effect that the divisible print tape 22 is imparted with the easy splitting property which allows itself to be split easily in the same direction as the slit 17c in the adhesive base material 17 after it is bonded to the divisible double-sided adhesive tape 24, characters or symbols on a printed face are protected by the divisible print tape 22 by bonding the divisible double-sided adhesive tape 24 to that printed face after the characters or symbols are printed by applying the ink 23a to the surface of the divisible print tape 22. This makes it possible to solve such a problem that the ink 23a may be peeled out due to rubbing during use, making the characters or symbols illegible.

Because the divisible print tape 22 is a polymer film having the easy splitting property given by the uniaxial drawing processing or biaxial drawing processing, the print medium 38 can be split linearly and divided with hands without use of scissors or the like due to the easy splitting property given by that drawing processing. Further, the print medium 38 can have an excellent texture when completed because the divisible print tape 22 is a polymer film. Further, the color of the print medium 38 can be selected freely by combination of the transparent divisible print tape 22 and a colored divisible double-sided adhesive tape 24.

Further, the divisible tape cassette 21 or 45 containing the print medium 38 has the tape type detecting holes 20 providing tape information corresponding to the configuration of the print medium 38. Accordingly, the operator can recognize the particulars of the contained print medium 38 when the tape producing apparatus 1 reads the tape information of the tape type detecting holes 20 prior to printing of characters so as to confirm it. This makes it possible to prevent an inconvenience of knowing the printed print medium being different from the desired one after the print operation, so that the operator does not have to do the print operation from the beginning. Further, the tape producing apparatus 1 can print appropriately on the print medium 38 based on a predetermined print condition corresponding to the tape information from the tape type detecting holes 20 read by the tape producing apparatus 1.

The tape producing apparatus 1 comprises: the tape type determining device comprising the tape cassette holding portion 8 in/from which the divisible tape cassette 21 or 45 can be loaded and unloaded, tape type detecting holes 20 and tape type detecting sensor 34 which determine the type of the divisible tape cassette 21 or 45, the CPU 50, the ROM 53, the tape type determining data 53r, the RAM 54 and the like; a width detecting device comprising the tape type detecting holes 20, tape type detecting sensor 34, the CPU 50, the ROM 53, the tape-type, tape-width, printable-character-size display and selection processing program 53e, the tape-width-printable-character-size data 53s, the tape type determining data 53r, the RAM 54 and the like for detecting the width of the print medium 38 based on the tape type determining device; a slit number detecting device comprising the tape type detecting holes 20, the tape type detecting sensor 34, the CPU 50, the ROM 53, the tape-type, tape-width, printable-character-size display and selection processing program 53e, the tape-width-printable-character-size data 53s, the tape type determining data, the RAM 54 and the like for detecting the quantity of the slits 17c in the print medium 38 based on the tape type determining device; a retrieving device comprising the tape type detecting holes 20, tape type detecting sensor 34, the CPU 50, the ROM 53, the tape-type, tape-width, printable-character-size display and selection processing program 53e, the font data 53p, the tape-width-printable-character-size data 53s, the tape type determining data 53r, the RAM 54 and the like for retrieving the point number of a maximum character printable on the width of each sectioned part of the print medium 38; and a display device comprising the LCD 5, the LCDC 58, the video RAM 59, the display CGROM 51, the display drive control program 53a, the CPU 50, the ROM 53, the RAM 54 and the like for displaying a result of retrieval based on the retrieving device. Consequently, when the divisible tape cassette 21 or 45 is loaded in the tape cassette holding portion 8, the quantity of sectioned parts of the print medium 38 formed of the divisible print tape and the divisible double-sided adhesive tape or the divisible print tape assembly in which the divisible print tape 22 and the divisible double-sided adhesive tape 24 are bonded to each other preliminarily, the width of each sectioned part of the print medium and the point number of a printable maximum character are displayed. As a result, the operator can obtain information necessary for input before he enters characters and others to be printed on the print medium 38. Thus, there is no necessity of trial printing, thereby preventing waste consumption of the print medium 38 to lead to elimination of excessive time and labor.

Further, the tape producing apparatus 1 further includes a print control device comprising the thermal head 11, the tape feed motor 36, the drive circuits 60 and 61, the print CGROM 52, the print drive program 53b, the divisible tape print processing program 53c, the divisible tape transverse print processing program 53d, the CPU 50, the ROM 53, the RAM 54 and the like for printing characters or symbols transversely on at least two sectioned parts of the print mediums 38 based on the results of the a width detecting device comprising the tape type detecting holes 20, the tape type detecting sensor 34, the CPU 50, the ROM 53, the tape-type, tape-width, printable-character-size display and selection processing program 53e, the tape-width-printable-character-size data 53s, the tape type determining data 53r, the RAM 54 and the like and the slit number detecting device comprising the tape type detecting holes 20, the tape type detecting sensor 34, the CPU 50, the ROM 53, the tape-type, tape-width, printable-character-size display and selection processing program 53e, the tape-width-printable-character-size data 53s, the tape type determining data, the RAM 54 and the like. Consequently, print mediums 38 having plural different widths can be produced, so that the print medium 38 as a minimum unit in which characters are printed is produced by sectioning a print medium formed of the divisible print tape 22 and the divisible double-sided adhesive tape 24 or the divisible print tape assembly 46 in which the divisible print tape 22 and the divisible double-sided adhesive tape 24 are bonded to each other preliminarily, these tapes being loaded in the tape producing apparatus 1, or the print medium 38 in which characters and others are printed transversely on at least two sectioned parts of the minimum unit is produced. As a result, the print mediums 38 having plural different widths in which characters and others can be produced. Thus, inconvenience of replacing the print medium 38 corresponding to the width of the print medium 38 to be produced each time can be eliminated.

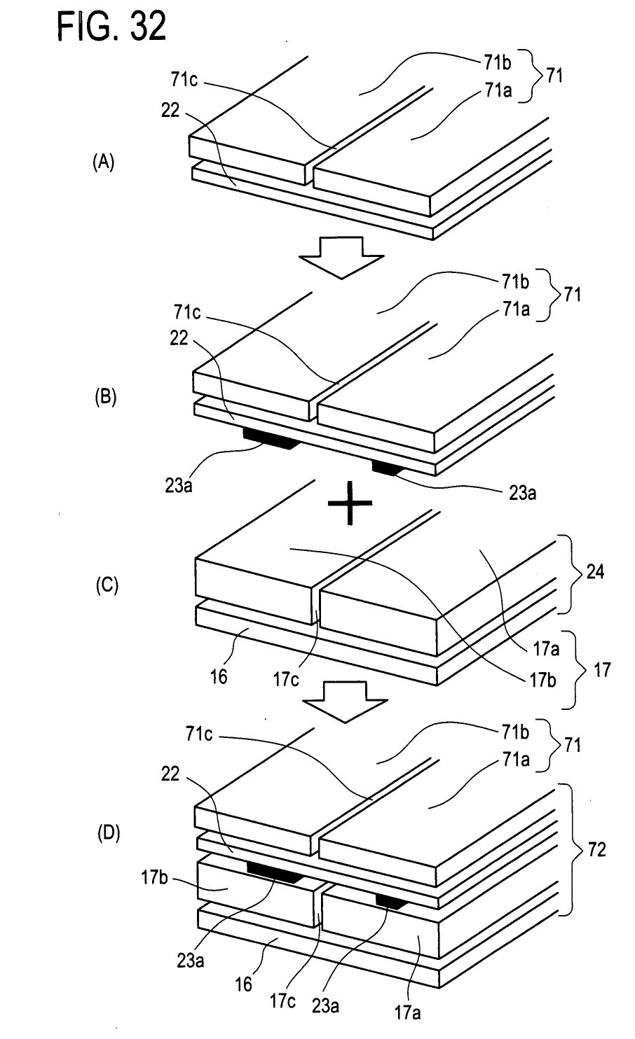

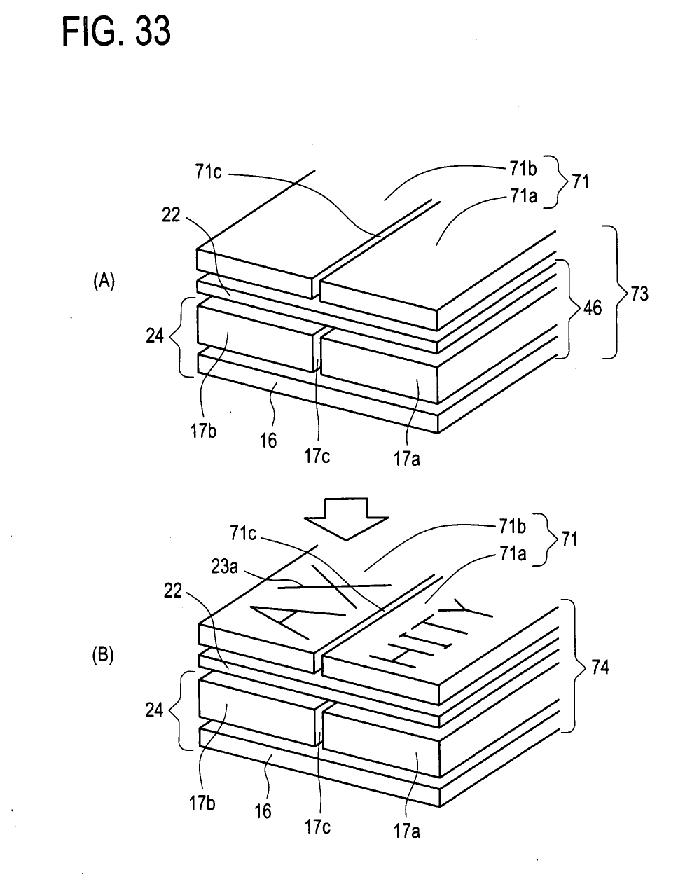

Next, the second embodiment of the disclosure will be described with reference to FIGS. 32 and 33. Like reference numerals are attached to components having the same function as the first embodiment. In this context, FIG. 32 is an explanatory diagram for explaining the process of printing characters and others to the divisible print tape 22 and bonding the divisible double-sided adhesive tape 24 so as to produce the laminate type label tape 72. As shown in FIG. 32, the cover film 71 is bonded to one side of the divisible print tape 22. This cover film 71 is split to a divisible cover film 71a and divisible cover film 71b through cover film slit 71c located at the same position as the slit 17c of the adhesive base material 17 which constitutes the divisible double-sided adhesive tape 24. This point is different from the label tape 35 of the first embodiment. The print medium 38 is formed of the divisible print tape 22 to which the cover film 71 is bonded and the divisible double-sided adhesive tape 24. Printing on the print medium 38 is executed to a face opposite to the side to which the cover film 71 is bonded of the divisible print tape 22. Thus, the member shown in FIG. 32 is contained in the laminate type divisible tape cassette 21 shown in FIG. 3 so as to produce a label tape 72 through the step shown in FIG. 32 (for the detail, see FIGS. 3 and 4).

FIG. 33 is an explanatory diagram for explaining the process of printing characters and others to the divisible print tape assembly 73 and producing a receptor type label tape 74 by passing between the tape drive roller 37 and the feed roller 15. As shown in this FIG. 33, the cover film 71 is bonded to the top face of the divisible print tape 22. Then, this cover film 71 is split to the divisible cover film 71a and divisible cover film 71b through cover film slit 71c located at the same position as the slit 17c of the adhesive base material 17 which constitutes the divisible double-sided adhesive tape 24. This point is different from the label tape 49 of the first embodiment. The print medium 38 is formed of the divisible print tape 22 to which the cover film 71 is bonded and the divisible double-sided adhesive tape 24 which is bonded to the divisible print tape 22 preliminarily. Further the printing on the print medium 38 is executed to a face of the cover film 71 bonded to the divisible print tape 22. Thus, the member shown in FIG. 33 is contained in the receptor type divisible tape cassette 45 shown in FIG. 5 so as to produce the label tape 4 through the step shown in FIG. 33 (for the detail, see FIGS. 5 and 6).

As described above, in the print medium 38 of the second embodiment, a cover film 71 having a cover film slit 71c in a position corresponding to the position of the slit 17c in the adhesive base material 17 constituting the divisible double-sided adhesive tape 24 is bonded to the top face of the divisible print tape 22. Consequently, the adhesive base material 17 which constitutes the divisible double-sided adhesive tape 24 and the cover film 71 serve as a reinforcing member for splitting the divisible print tape 22 at the slit 17c provided in the adhesive base material 17 which constitutes the divisible double-sided adhesive tape 24 and the cover film slit 71c provided in the cover film 71. Thus, the divisible print tape 22 can be prevented from being split at other portion than the slit 17c and the cover film slit 71c, provided in the adhesive base material 17 which constitutes the divisible double-sided adhesive tape 24 and the cover film 71 respectively.

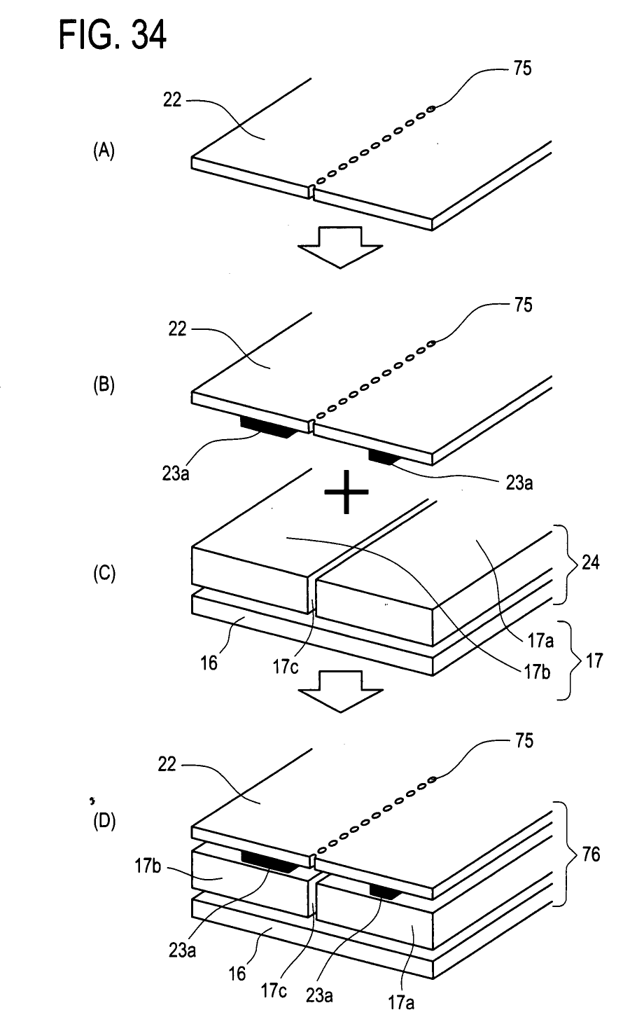

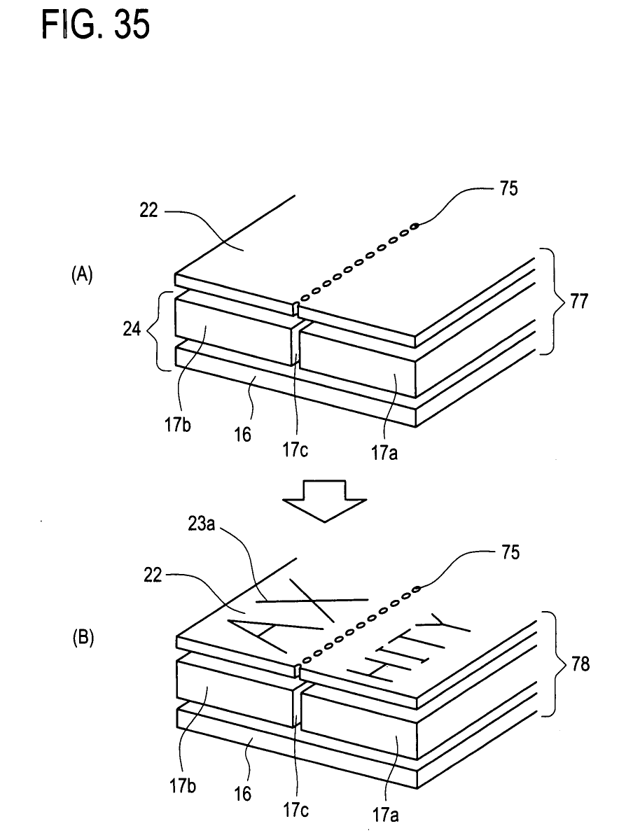

A third embodiment of the disclosure will be described with reference to FIGS. 34 and 35. Like reference numerals are attached to components having the same function as the first embodiment and the second embodiment. FIG. 34 is an explanatory diagram for explaining the process of printing characters and others to the divisible print tape 22 and bonding to the divisible double-sided adhesive tape 24 so as to produce a laminate type label tape 76. As shown in FIG. 34, the division assist holes are formed in line at the same position as the slit 17c in the adhesive base material 17 which constitutes the divisible double-sided adhesive tape 24 in the divisible print tape 22. This point is different from the label tape 35 and the label tape 72 produced according to the first embodiment and the second embodiment. The print medium 38 is formed of the divisible print tape 22 having division assist holes 75 formed in line like a dotted line and the divisible double-sided adhesive tape 24. Further, printing on the print medium 38 is executed to a face to be bonded to the divisible double-sided adhesive tape 24 of the divisible print tape 22. Thus, the member shown in FIG. 34 is contained in the laminate type divisible tape cassette 21 shown in FIG. 3 so as to produce a label tape 76 through the step shown in FIG. 34 (for the detail, see FIGS. 3 and 4).

FIG. 35 is an explanatory diagram for explaining the process of printing characters and others to the divisible print tape assembly 77 and producing a receptor type label tape 78 by passing between the tape drive roller 37 and the feed roller 15. As shown in FIG. 35, the division assist holes 75 are formed in the position corresponding to the position of the slit 17c in the adhesive base material 17 which constitutes the divisible double-sided adhesive tape 24 in the divisible print tape 22. This point is different from the label tape 49 and the label tape 74 produced according to the first embodiment and the second embodiment respectively. Then, the print medium 38 is formed of the divisible print tape 22 formed with the division assist holes 75 and the divisible double-sided adhesive tape 24 bonded to the divisible print tape 22. Further the printing on the print medium 38 is carried out to the top face of the divisible print tape 22. Thus, the member shown in FIG. 35 is contained in the receptor type divisible tape cassette shown in FIG. 5 so as to produce a label tape 78 through the step shown in FIG. 35 (for the detail, see FIGS. 5 and 6).

As described above, the print medium 38 of the third embodiment has the division assist holes 75 formed in line in the position corresponding to the position of the slit 17c in the adhesive base material 17 which constitutes the divisible double-sided adhesive tape 24 in the divisible print tape 22, so that the divisible print tape 22 has the easy splitting property in the same direction as the slit 17c in the adhesive base material 17 which constitutes the divisible double-sided adhesive tape 24. By providing the divisible print tape 22 with the division assist holes 75 perforated in line in the position corresponding to the position of the slit 17c in the adhesive base material 17 which constitutes the divisible double-sided adhesive tape 24, the divisible print tape 22 can be split securely at the slit 17c in the adhesive base material 17 which constitutes the divisible double-sided adhesive tape 24 without use of scissors or the like.

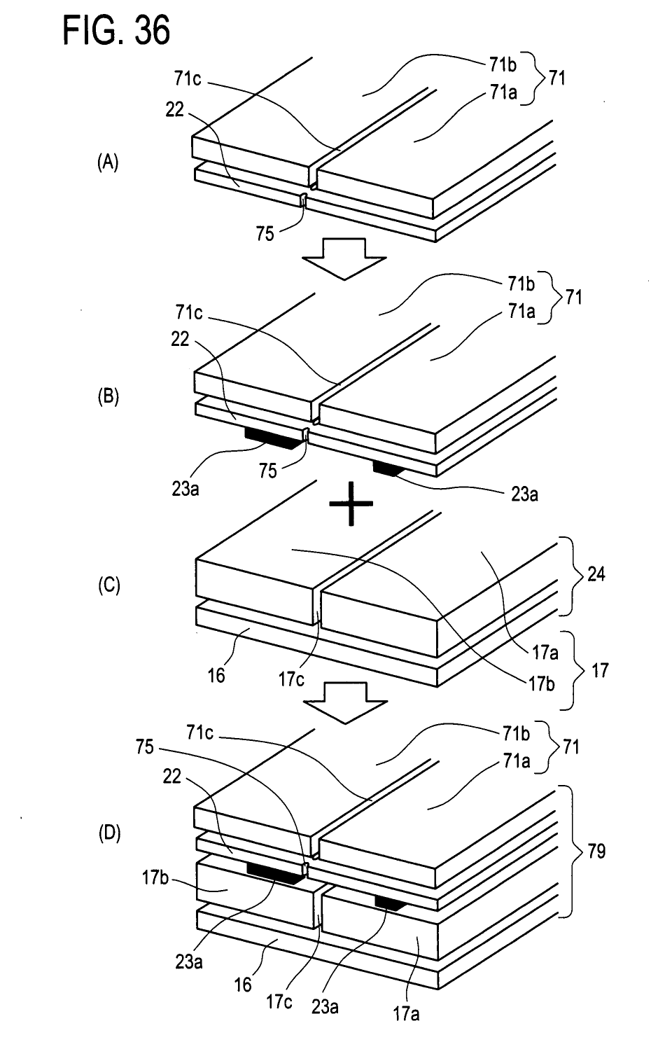

As shown in FIG. 36 for example, the easy splitting property can be exerted excellently by synthesizing FIG. 32 with FIG. 34. FIG. 36 is an explanatory diagram for explaining the process of printing characters and others on the divisible print tape 22 and bonding the divisible adhesive tape 24 so as to produce a laminate type label tape 79.

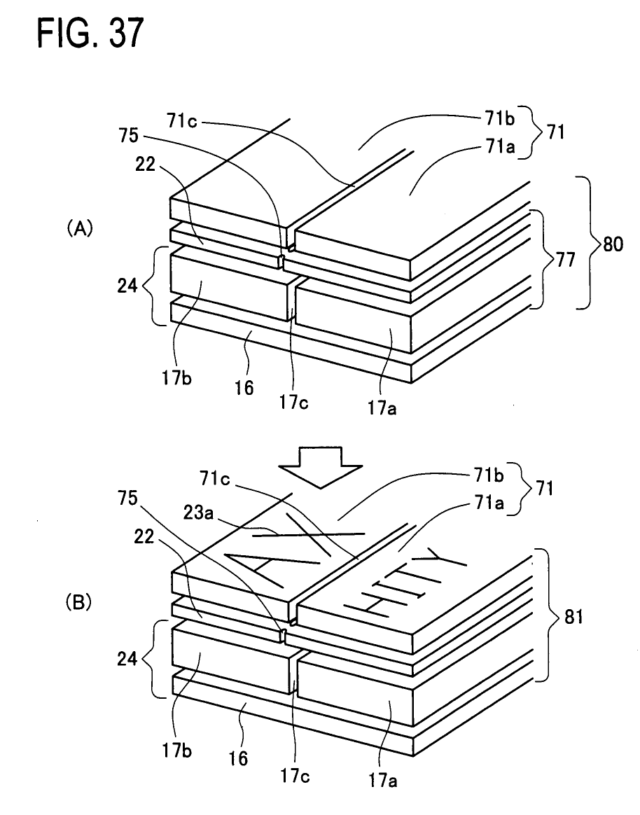

Further, as shown in FIG. 37, the easy splitting property can be exerted excellently by synthesizing FIG. 33 with FIG. 35. FIG. 37 is an explanatory diagram for explaining the process of printing characters and others on the divisible print tape assembly 80 and producing a receptor type label tape by passing between the tape drive roller 37 and the feed roller 15.

While the presently exemplary embodiment has been shown and described, it is to be understood that this disclosure is for the purpose of illustration and that various changes and modifications may be made without departing from the scope of the disclosure as set forth in the appended claims.

What is claimed is:

1. A print medium comprising a print tape and a double-sided adhesive tape, the print tape having a surface on which characters and symbols are to be printed with ink adhered thereto, wherein
the double-sided adhesive tape includes an adhesive base material formed with a slit extending in a direction perpendicular to a width of the double-sided adhesive tape, and
the print tape has an easy splitting property of being split in the same direction as the extending direction of the slit of the double-sided adhesive tape.

2. The print medium according to claim 1, wherein a cover film is adhered to an upper surface of the print tape, the cover film having a cover film slit in a position corresponding to a position of the slit of the double-sided adhesive tape.

3. The print medium according to claim 1, wherein the print tape is provided with holes formed in line in a position corresponding to a position of the slit of the double-sided adhesive tape.

4. The print medium according to claim 1, wherein the print tape is a polymer film having an easy splitting property given by one of an uniaxial drawing processing and a biaxial drawing processing.

5. A tape cassette that contains the print medium set forth in claim 1 and has a detecting part providing tape information according to a type of the print medium.

6. A tape producing apparatus comprising:
a tape cassette holding portion in which the tape cassette set forth in claim 5 can be loaded/unloaded;
a type determining device that determines a type of the tape cassette;
a width detecting device that detects a width of the print medium based on a result of the type discrimination device;
a slit number detecting device that detects the number of slits of the print medium based on a result of the type determining device;
a retrieving device that retrieves a maximum point size of a character printable on each part of the print medium to be divided in a width direction thereof, based on results of the width detecting device and the slit number detecting device; and
a display device that displays a result retrieved by the retrieving device.

7. The tape producing apparatus according to claim 6, further comprising a print control device that prints characters and symbols transversely on at least two or more parts of the print medium based on the results of the width detecting device and the slit number detecting device.

8. A print medium comprising a print tape and a double-sided adhesive tape, the print tape having a surface on which letters and symbols are to be printed with ink adhered thereto and the surface being bonded to the double-sided adhesive tape, wherein
the double-sided adhesive tape includes an adhesive base material formed with a slit extending in a direction perpendicular to a width of the double-sided adhesive tape, and
the print tape has an easy splitting property of being split in the same direction as the extending direction of the slit of the double-sided adhesive tape after the print tape is bonded to the double-sided adhesive tape.

9. The print medium according to claim 8, wherein a cover film is adhered to an upper surface of the print tape, the cover film having a cover film slit in a position corresponding to a position of the slit of the double-sided adhesive tape.

10. The print medium according to claim 8, wherein the print tape is provided with holes formed in line in a position corresponding to a position of the slit of the double-sided adhesive tape.

11. The print medium according to claim 8, wherein the print tape is a polymer film having an easy splitting property given by one of a uniaxial drawing processing and a biaxial drawing processing.

12. A tape cassette that contains the print medium set forth in claim 8 and has a detecting part providing tape information according to a type of the print medium.

13. A tape producing apparatus comprising:
a tape cassette holding portion in which the tape cassette set forth in claim 12 can be loaded/unloaded;
a type determining device that determines a type of the tape cassette;
a width detecting device that detects a width of the print medium based on a result of the type discrimination device;
a slit number detecting device that detects the number of slits of the print medium based on a result of the type determining device;
a retrieving device that retrieves a maximum point size of a character printable on each part of the print medium to be divided in a width direction thereof, based on results of the width detecting device and the slit number detecting device; and
a display device that displays a result retrieved by the retrieving device.

14. The tape producing apparatus according to claim 13, further comprising print control device that prints characters and symbols transversely on at least two or more parts of the print medium based on the width detecting device and the slit number detecting device.
